(19) United States
(12) Patent Application Publication
(10) Pub. No.: US 2005/0273368 A1
(43) Pub. Date: Dec. 8, 2005

(54) System and method for capturing an image

(76) Inventors: Bruce Van Hutten, Chapin, SC (US); Kuldeep Chaturvedi, Norda (IN)

Correspondence Address: MEYERTONS, HOOD, KIVLIN, KOWERT & GOETZEL, P.C., P.O. BOX 398, AUSTIN, TX, 78767-0398, US

(21) Appl. No.: 11/054,327

(22) Filed: Feb. 9, 2005

Related U.S. Application Data
(63) Continuation of application No. 10/853,159, filed on May 26, 2004.

(51) Int. Cl. G06F 17/60

(52) U.S. Cl. 705/4

(57) ABSTRACT

In various embodiments, a user may communicate with an insurance claim processing system. A user may access insurance claims or policies and the Internet. A user may capture an image of a website. A user system may link the image with one or more identifiers. The image may be transmitted to and stored by an insurance claim processing system. Stored images may be recalled by a user system and/or an insurance claim processing system. In some embodiments, a user may communicate with financial service organization system. A user may access financial transactions and the Internet. A user may capture an image of a website. A user system may link an image with one or more identifiers. An image and one or more identifiers may be transmitted to and stored by a financial service organization system. Stored images may be recalled by a user system and/or a financial service organization system.

### PRIORITY CLAIM

This application is a continuation application of U.S. patent application Ser. No. 10/853,159 entitled “System and Method for Capturing an Image.”

### BACKGROUND OF THE INVENTION

1. Field of the Invention

The present invention generally relates to computer systems. In particular, embodiments relate to systems and methods of capturing images from websites and storing images on an insurance claim processing system or a financial service organization system.

2. Brief Description of the Related Art

During the past several years, many insurance companies and financial service organizations have been using computer-based and knowledge-based claim-processing systems to process, evaluate, analyze and estimate thousands of claims in a fair and consistent manner. A knowledge-based claim-processing system includes an expert system which utilizes and builds a knowledge base to assist the user in decision making. It may allow the insurance companies to define new rules and/or use previously defined rules, in real-time. The business rules are generally written by industry experts to evaluate legal, medical, insurance conditions before arriving at a valuation of a claim.

In the past, such knowledge-based systems have been limited to traditional computing architectures such as mainframes and stand-alone personal computers. Therefore, it was necessary to install and maintain client software as well as server software for these knowledge-based systems in particular physical locations. With the growth of the Internet, however, many personal computers may now be granted client access to servers distributed all over the world. It may be desirable to utilize a knowledge-based system for insurance claim processing which is configured to be accessed over the Internet or through a web browser. It may also desirable to utilize a knowledge-based system for financial transaction processing and/or management which is configured to be accessed over the Internet or through a web browser.

Personnel involved in handling insurance policies and claims enter information into a knowledge-based system accessed through a web browser. Computer systems can perform calculations needed for insurance claim processing including, but not limited to, calculating insurance premiums, claim payouts, and/or annuity premiums. In addition, personnel may be able to use the Internet to research different aspects of an insurance claim (e.g., the address of an insurance claimant, government regulations, regulated premium rates).

The context of websites or web pages, however, may not be permanent. Often, as information, such as regulated premium rates change, a website may be updated. When personnel and/or auditors later review an insurance policy or claim, parameters used to calculate claims and/or premiums may be difficult to obtain (e.g., the person who entered information no longer is with the company or does not remember what information was entered; the content of a website used to obtain information, such as premium rates, has changed; and/or inadequate record keeping).

Financial service organizations also rely on computer systems to process, manage, and/or store financial transactions. Financial transactions include, but are not limited to, credit card issuances, credit card transactions, commercial and/or personal loans, and/or bank transactions. Personnel may enter information, such as interest rates, into a knowledge-based system accessed through a web browser for later access and/or to perform calculations. Calculations may include, but are not limited to, interest rates for loans, interest accrued, total principal balance, credit card account balance, total transaction amount for a credit card holder, etc. Personnel may also access the Internet to research aspects of a financial transaction including, but not limited to, credit history, collateral verification and/or information, federal regulations, federal interest rates, Consumer Price Index (“CPI”) and/or other indices, and common interest rates available in the market.

Often personnel may access a financial service organization template for calculations via the Internet. A person may enter parameters (e.g., transaction amount, interest rate, credit score, etc.); however, a person may not remember parameters entered after the financial service organization template processes the parameters. Auditors may have difficulty evaluating financial transactions without all the information used in a financial transaction.

### SUMMARY OF THE INVENTION

Herein we describe systems and methods for capturing an image of a website and storing the image in an insurance claim processing system. The image of the website may be a substantially similar representation of the website. The system, in some embodiments, may capture an image of a website accessed by a user that is a substantially similar representation of the website. The image may be linked to one or more identifiers. An image may be linked to more than one identifier. In managing insurance policies the identifier includes, but is not limited to, a policy name and/or number, a policyholder name and/or number, a user system name and/or number, a user name and/or number, a user entered name and/or number, a date, and/or a time. A system may transmit an image and one or more identifiers from a user system to an insurance claim processing system where the image is stored in a memory or a database. An aspect of the system is that the image may be recalled by a user system. An insurance claim processing system may recall an image associated with one or more identifiers when a user requests data associated with one or more identifiers.

In some embodiments, insurance policies and claims may be stored on a user system. Insurance policies and claims may be stored on the insurance claim processing system. A user may access an insurance policy across a network via one or more internet protocols. In one embodiment, a user may access an insurance policy and/or create a claim by accessing the insurance claim processing system through the Internet.

In some embodiment, an image of a website may be captured by reproducing similar pixels of a website in an image file. The image may be linked with one or more identifiers. Linking an identifier with an image may include inserting at least one identifier in the image. In certain embodiments, an image is automatically linked with one or more identifiers. Linked identifiers may be transmitted along with an image to an insurance claim processing system.

In one embodiment, captured images may be transmitted to an insurance claim processing system via the Internet. The insurance claim processing system may be capable of receiving transmitted images and sending a message to the user system after receiving the images. The insurance claim processing system may store images in a database and categorize the images.

In some embodiments, an insurance claim processing system may recall an image associated with an insurance policy when a user requests the insurance policy. An insurance claim processing system may recall images by comparing identifiers from requested insurance policies with identifiers linked to images in a database. The insurance claim processing system may recall images with identifiers that are similar to the identifiers associated with a requested insurance policy. Recalling images may include transmitting a link to images to the user system.

In certain embodiments, the user system may be coupled to an insurance claim processing system through a network. A user system may include a CPU and a memory coupled to the CPU. The user system memory may store program instructions that may be at least partially executed by the CPU of the user system. The program instructions may include requesting an insurance claim or policy through a web browser. The insurance policy may be stored on a memory of the insurance claim processing system. The user system may then access a website through the web browser. A user may desire to capture an image of the website. In an embodiment, program instructions may include capturing the image of the website through the web browser. The program instructions may include linking the image to one or more identifiers and/or transmitting the image to an insurance claim processing system.

In an embodiment, an insurance claim processing system may include a CPU and a memory coupled to the CPU. The insurance claim processing system memory may store programs that may be at least partially executed by the CPU of the insurance claim processing system. The program instructions may include receiving the image from the user system and/or storing the image and one or more identifiers in a memory of the insurance claim processing system.

In some embodiments, managing insurance claims and policies may include accessing an insurance policy through a user system across a network via one or more Internet protocols. A user may access an insurance policy through a web browser. The insurance policy may be stored on an insurance claim processing system. A user may access a website across the network via one or more Internet protocols (e.g., TCP/IP, HTTP). A user may access a website through the same web browser the user accessed the insurance claim or policy through. A user system may capture an image of the website and link the image to one or more identifiers. A user system may transmit the image to the insurance claim processing system across a network via one or more Internet protocols. An insurance claim processing system may receive the image and store the image and one or more identifiers in a memory of the insurance claim processing system.

In certain embodiments, a system for managing insurance claims and policies may include a carrier medium with program instructions. The program instructions may include transmitting an insurance claim or policy to a user system across a network via one or more Internet protocols when a user requests the insurance claim or policy. A user may also access a website across a network via one or more Internet protocols. Program instructions may include capturing an image of the accessed website and linking the image to one or more identifiers. In an embodiment, the program instructions may include transmitting the image across a network via one or more Internet protocols to the insurance claim processing system from the user system. The program instructions may include storing the image and one or more identifiers in a memory of the insurance claim processing system. In one embodiment, program instructions may include sending a message to a user system after receiving the image.

In certain embodiments, security in web browsers may interfere with capturing images of websites. A prompt on a user system may verify that capturing an image of a website is not harmful to the website and/or illegal. The prompt may allow the web browser to capture an image of the website. An image capturing program at least partially running on the user system may automatically verify that capturing an image of a website is not harmful to the website and/or illegal.

In some embodiments, systems and methods include capturing an image of a website and storing the image in a financial service organization system. The image of the website may be a substantially similar representation of the website. The system, in some embodiments, may capture an image of a website accessed by a user that is a substantially similar representation of the website. The image may be linked to an identifier. In managing financial transactions the identifier includes, but is not limited to, a financial transaction name and/or number, a borrower name and/or number, a loan name and/or number, a user system name and/or number, a user name and/or number, a user entered name or number, a date, and/or a time. A system may transmit an image and an identifier from a user system to a financial service organization where the image is stored in a memory or a database. An aspect of the system is that the image may be recalled by a user system. A financial service organization system may recall an image associated with one or more identifiers when a user requests data associated with one or more identifiers.

In an embodiment, financial transactions may be stored on a user system. Financial transactions may be stored on a financial service organization system. A user may access and/or create a financial transaction by accessing the financial service organization system through the Internet.

In some embodiment, an image of a website may be captured by reproducing similar pixels of a website in an image file. The image may be linked with one or more identifiers. Linking an identifier with an image may include inserting at least one identifier in the image. In certain embodiments, an image is automatically linked with one or more identifiers. Linked identifiers may be transmitted along with an image to a financial service organization system.

In one embodiment, captured images may be transmitted to a financial service organization system via the Internet. The financial service organization system may be capable of receiving transmitted images and sending a message to the user system after receiving the images. The financial service organization system may store images in a database and categorize the images.

In some embodiments, a financial service organization system may recall an image associated with a financial transaction when a user requests the financial transaction. A financial service organization system may recall images by comparing identifiers from requested financial transactions with identifiers linked to images in a database. The financial service organization system may recall images with identifiers that are similar to the identifiers associated with a requested financial transaction. Recalling images may include transmitting a link to images to the user system.

In certain embodiments, the user system may be coupled to a financial service organization system through a network. A user system may include a CPU and a memory coupled to the CPU. The user system memory may store program instructions that may be at least partially executed by the CPU of the user system. The program instructions may include requesting a financial transaction through a web browser. The insurance policy may be stored on a memory of the financial service organization system. The user system may then access a website through the web browser. A user may desire to capture an image of the website. In an embodiment, program instructions may include capturing the image of the website through the web browser. The program instructions may include linking the image to one or more identifiers and/or transmitting the image to a financial service organization system.

In an embodiment, a financial service organization system may include a CPU and a memory coupled to the CPU. The financial service organization system memory may store programs that may be at least partially executed by the CPU of the financial service organization system. The program instructions may include receiving the image from the user system and/or storing the image and one or more identifiers in a memory of the financial service organization system.

In some embodiments, managing financial transactions may include accessing a financial transaction through a user system across a network via one or more Internet protocols. A user may access a financial transaction through a web browser. The financial transaction may be stored on a financial service organization system. A user may access a website across the network via one or more Internet protocols (e.g., TCP/IP, HTTP). A user may access a website through the same web browser the user accessed the financial transaction through. A user system may capture an image of the website and link the image to one or more identifiers. A user system may transmit the image to the financial service organization system across a network via one or more Internet protocols. A financial service organization system may receive the image and store the image and one or more identifiers in a memory of the financial service organization system.

In certain embodiments, a system for managing financial transactions may include a carrier medium with program instructions. The program instructions may include transmitting a financial transaction to a user system across a network via one or more Internet protocols when a user requests the financial transaction. A user may also access a website across a network via one or more Internet protocols. Program instructions may include capturing an image of the accessed website and linking the image to one or more identifiers. In an embodiment, the program instructions may include transmitting the image across a network via one or more Internet protocols to the financial service organization system from the user system. The program instructions may include storing the image and one or more identifiers in a memory of the financial service organization system. In one embodiment, program instructions may include sending a message to a user system after receiving the image.

In certain embodiments, security in web browsers may interfere with capturing images of websites. A prompt on a user system managing financial transactions may verify that capturing an image of a website is not harmful to the website and/or illegal. The prompt may allow the web browser to capture an image of the website. An image capturing program at least partially running on the user system may automatically verify that capturing an image of a website is not harmful to the website and/or illegal.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings in which:

FIG. 1 illustrates a flowchart of an embodiment for transmitting an image to an insurance claim processing system.

FIG. 2 illustrates a flowchart of an embodiment for capturing an image of a website.

FIG. 3 illustrates a flowchart of an embodiment for transmitting an image to a financial service organization.

FIG. 4 illustrates a flowchart of an embodiment for capturing an image of a website.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF EMBODIMENTS

Herein we describe a system and method for the managing insurance claims and policies between a user system and an insurance claim processing system. A system and method for managing transactions between a user system and a financial service organization system is also described.

Managing Insurance Claims and Policies

In some embodiments, a user may access documents such as insurance claims and policies stored on a server of an insurance claim processing system through a web browser. A web browser may include more than one section, such as toolbars and icons. When accessing an insurance claim or policy through a web browser, a web browser may include at least two sections. At least one section of the web browser includes a viewable window. A viewable window may be able to display documents, insurance policies, and/or web pages. A section of the web browser may include policy information including, but not limited to, policy number, policyholder name, history of the policy, etc. A section of the web browser may include links to documents associated with the insurance claim or policy. Features of the described sections may be combined in a single or several sections in a web browser.

In some embodiments, a user may access a website and capture an image of the website. Capturing an image, in the context of this application, refers creating a duplicate, a copy, a replica, a likeness, a reproduction, a representation, a similar image, and/or an impression or view of something permanent or transitory. An image may be linked on the user system or a server of an insurance claim processing system to an identifier associated with an insurance policy. An image may be transmitted to and stored in an insurance claim processing system. A user may recall an image by entering one or more identifiers in the user system. A user may recall an image by recalling data associated with one or more identifiers also associated with an image (e.g., images linked to a life insurance policy number may be recalled by a user system when a user recalls the life insurance policy, etc.). A user system may transmit the requested identifier to an insurance claim processing system. An insurance claim processing system or may recall the one or more images associated with the requested identifier.

Insurance policies may be managed between a user system and an insurance claim processing system. A user system may be coupled to an insurance claim processing system. Wires, wide area networks (“WAN”), local area networks (“LAN”), and combinations thereof may couple a user system and an insurance claim processing system. A WAN may be a network that spans a relatively large geographical area. The Internet is an example of WAN. A WAN may include a variety of heterogeneous computer systems and networks that may be interconnected in a variety of ways and that may run a variety of software applications.

One or more LANs may be coupled to a WAN. A LAN may be a network that spans a relatively small area compared to a WAN. A LAN may be confined to a single building or group of buildings. Each node (e.g., user system, individual computer system or device) on a LAN may have its own CPU with which it may execute programs, and each node may also be able to access data and devices anywhere on a LAN. A LAN may allow many users to share devices (e.g., printers) and data stored on file servers. A LAN may be characterized by a variety of types of topology (e.g., the geometric arrangement of devices on the network), of protocols (e.g., the rules and encoding specifications for sending data, and whether the network uses a peer-to-peer or user/server architecture), and of media (e.g., twisted-pair wire, coaxial cables, fiber optic cables, and/or radio waves). A LAN may be coupled to other computer systems and/or other devices and/or other LANs through a WAN.

One or more mainframe computer systems may be coupled to a WAN. A mainframe may be coupled to a storage device or file server and mainframe terminals. An insurance claim processing system may include a combination of mainframes and/or mainframe terminals. Mainframe terminals may access data stored in the storage device or file server coupled to or included in mainframe computer system. A user system may be a mainframe terminal.

A WAN may also include computer systems (e.g., user systems, insurance claim processing systems, etc.) connected to a WAN individually and not through a LAN. For example, WAN may include computer systems that may be geographically remote and connected to each other through the Internet.

A computer system (e.g., user systems, insurance claim processing systems, etc.) may also include a display device such as monitor, an alphanumeric input device such as keyboard, and a directional input device such as mouse. A computer system (e.g., user systems, insurance claim processing systems, etc.) may typically include components such as CPU with an associated memory such as floppy disks and/or CD-ROMs. Memory may store program instructions for computer programs. Program instructions may be executable by CPU. The term “memory” is intended to include any installation medium, e.g., a CD-ROM or floppy disks, a computer system memory such as DRAM, SRAM, EDO RAM, Rambus RAM, etc., or any non-volatile memory such as a magnetic media, e.g., a hard drive or optical storage. Memory may also include other types of memory or combinations thereof. In addition, memory may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, personal digital assistant (“PDA”), television system or other device. In general, the term “computer system” may refer to any device having a processor that executes instructions from a memory.

Computer system may be operable to execute computer programs to implement computer-implemented systems. It may be desirable to utilize a knowledge-based system for insurance claim processing which is configured to be accessed over the Internet or through a web browser, such as those described in the following applications, which are fully incorporated herein by reference as if set forth herein:

U.S. patent application Ser. No. 09/603,307 to Childress et al., entitled “SYSTEM AND METHOD FOR PROCESSING INSURANCE CLAIMS USING A TABLE OF CONTENTS” filed on Jun. 23, 2000;

U.S. patent application Ser. No. 09/603,129 to Jones, entitled “SYSTEM AND METHOD FOR IDENTIFYING CRITICAL FACTORS AFFECTING AN ESTIMATED VALUE INCLUDED IN AN INSURANCE CLAIM CONSULTATION REPORT” filed on Jun. 23, 2000;

U.S. patent application Ser. No. 09/603,662 to Childress, entitled “RELEVANCE CALCULATION FOR A REFERENCE SYSTEM IN AN INSURANCE CLAIMS PROCESSING SYSTEM” filed on Jun. 23, 2000;

U.S. patent application Ser. No. 09/603,308 to Wolfe et al., entitled “SYSTEM AND METHOD FOR EXTERNALIZATION OF FORMULAS FOR ASSESSING DAMAGES” filed on Jun. 23, 2000;

U.S. patent application Ser. No. 09/603,144 to Jones et al., entitled “SYSTEM AND METHOD FOR EXTERNALIZATION OF RULES FOR ASSESSING DAMAGES” filed on Jun. 23, 2000;

U.S. patent application Ser. No. 09/602,687 to Lorenz, entitled “WEB-ENABLED SYSTEM AND METHOD FOR ASSESSING DAMAGES” filed on Jun. 23, 2000;

PCT Patent Application No. PCT/US01/20030 to Jones et al., entitled “SYSTEM AND METHOD FOR PROCESSING INSURANCE CLAIMS” filed on Jun. 21, 2001;

U.S. patent application Ser. No. 09/603,302 to Childress, entitled “DYNAMIC HELP SYSTEM FOR AN INSURANCE CLAIMS PROCESSING SYSTEM” filed on Jun. 23, 2000;

U.S. patent application Ser. No. 09/602,691 to Childress, entitled “GRAPHICAL USER INTERFACE WITH A HIDE/SHOW FEATURE FOR A REFERENCE SYSTEM IN AN INSURANCE CLAIMS PROCESSING SYSTEM” filed on Jun. 23, 2000;

U.S. patent application Ser. No. 09/603,130 to Lorenz, entitled “RESET BUTTON FOR WEB-ENABLED SYSTEM AND METHOD FOR ASSESSING DAMAGES” filed on Jun. 23, 2000;

U.S. patent application Ser. No. 09/603,303 to Lorenz, entitled “INTERNET-ENABLED SYSTEM AND METHOD FOR ASSESSING DAMAGES” filed on Jun. 23, 2000;

U.S. patent application Ser. No. 09/603,304 to Lorenz, entitled “PRICING MODELS FOR WEB-ENABLED SYSTEM AND METHOD FOR ASSESSING DAMAGES” filed on Jun. 23, 2000;

U.S. patent application Ser. No. 09/603,306 to Wolfe, entitled “SYSTEM AND METHOD FOR DISPLAYING MESSAGES USING A MESSAGES TABLE” filed on Jun. 23, 2000;

U.S. patent application Ser. No. 10/422,632 to Wahlbin, entitled “GRAPHICAL INPUT DISPLAY IN AN INSURANCE PROCESSING SYSTEM” filed on Apr. 24, 2003;

U.S. patent application Ser. No. 10/422,450 to Wahlbin et al., entitled “METHOD AND SYSTEM FOR DETERMINING MONETARY AMOUNTS IN AN INSURANCE PROCESSING SYSTEM” filed on Apr. 24, 2003;

U.S. Patent Application Publication No. 2004-0054557 published on Mar. 18, 2004 to Wahlbin et al., entitled “COMPUTERIZED METHOD AND SYSTEM FOR ESTIMATING PREMISES LIABILITY FOR AN ACCIDENT” filed on Sep. 9, 2002;

U.S. Patent Application Publication No. 2004-0054558 published on Mar. 18, 2004 to Wahlbin et al., entitled “COMPUTERIZED METHOD AND SYSTEM FOR DETERMINING CLAIMANT STATUS IN PREMISES LIABILITY FOR AN ACCIDENT” filed on Sep. 9, 2002;

U.S. Patent Application Publication No. 2004-0049409 published on Mar. 11, 2004 to Wahlbin et al., entitled “COMPUTERIZED METHOD AND SYSTEM FOR DETERMINING BREACH OF DUTY IN PREMISES LIABILITY FOR AN ACCIDENT” filed on Sep. 9, 2002;

U.S. Patent Application Publication No. 2004-0054556 published on Mar. 18, 2004 to Wahlbin et al., entitled “COMPUTERIZED METHOD AND SYSTEM FOR DETERMINING CAUSATION IN PREMISES LIABILITY FOR AN ACCIDENT” filed on Sep. 9, 2002;

U.S. Patent Application Publication No. 2004-0054559 published on Mar. 18, 2004 to Wahlbin et al., entitled “COMPUTERIZED METHOD AND SYSTEM FOR DETERMINING THE CONTRIBUTION OF DEFENSES TO PREMISES LIABILITY FOR AN ACCIDENT” filed on Sep. 9, 2002;

U.S. Patent Application Publication No. 2002-0069091 published on Jun. 6, 2002 to Wahlbin et al., entitled “COMPUTERIZED METHOD OF LIABILITY ASSESSMENT FOR AN ACCIDENT” filed on Oct. 2, 2001;

U.S. Patent Application Publication No. 2002-0082873 published on Jun. 27, 2002 to Wahlbin et al., entitled “COMPUTERIZED METHOD AND SYSTEM OF DETERMINING RIGHT OF WAY AND LIABILITY FOR AN ACCIDENT” filed on Oct. 2, 2001;

U.S. Patent Application Publication No. 2002-0062234 published on May 23, 2002 to Wahlbin et al., entitled “COMPUTERIZED METHOD AND SYSTEM OF ESTIMATING LIABILITY AND RANGE OF LIABILITY FOR AN ACCIDENT” filed on Oct. 2, 2001;

U.S. Patent Application Publication No. 2002-0055860 published on May 9, 2002 to Wahlbin et al., entitled “COMPUTERIZED METHOD AND SYSTEM OF DETERMINING RIGHT OF WAY IN AN ACCIDENT” filed on Oct. 2, 2001;

U.S. Patent Application Publication No. 2002-0062233 published on May 23, 2002 to Wahlbin et al., entitled “COMPUTERIZED METHOD AND SYSTEM OF ASSESSING LIABILITY FOR AN ACCIDENT USING IMPACT GROUPS” filed on Oct. 2, 2001;

U.S. Patent Application Publication No. 2002-0059097 published on May 16, 2002 to Wahlbin et al., entitled “COMPUTERIZED METHOD AND SYSTEM OF ASSIGNING AN ABSOLUTE LIABILITY VALUE FOR AN ACCIDENT” filed on Oct. 2, 2001;

U.S. Patent Application Publication No. 2002-0087363 published on Jul. 4, 2002 to Wahlbin et al., entitled “COMPUTERIZED METHOD AND SYSTEM OF LIABILITY ASSESSMENT FOR AN ACCIDENT USING ENVIRONMENTAL, VEHICLE, AND DRIVER CONDITIONS AND DRIVER ACTIONS” filed on Oct. 2, 2001;

U.S. Patent Application Publication No. 2002-0091504 published on Jul. 11, 2002 to Wahlbin et al., entitled “COMPUTERIZED METHOD AND SYSTEM FOR ACCUMULATING LIABILITY ESTIMATES” filed on Oct. 2, 2001;

U.S. Patent Application Publication No. 2002-0128881 published on Sep. 12, 2002 to Wahlbin et al., entitled “COMPUTERIZED METHOD AND SYSTEM FOR ADJUSTING LIABILITY ESTIMATES IN AN ACCIDENT LIABILITY ASSESSMENT PROGRAM” filed on Oct. 2, 2001;

U.S. Patent Application Publication No. 2002-0062232 published on Sep. 12, 2002 to Wahlbin et al., entitled “COMPUTERIZED METHOD AND SYSTEM FOR ADJUSTING LIABILITY ESTIMATION FACTORS IN AN ACCIDENT LIABILITY ASSESSMENT PROGRAM” filed on Oct. 2, 2001;

U.S. Patent Application Publication No. 2002-0062235 published on May 23, 2002 to Wahlbin et al., entitled “COMPUTERIZED METHOD AND SYSTEM FOR PROVIDING CLAIMS DATA TO AN ACCIDENT LIABILITY ASSESSMENT PROGRAM” filed on Oct. 2, 2001;

U.S. Patent Application Publication No. 2002-0059084 published on May 16, 2002 to Wahlbin et al., entitled “COMPUTERIZED METHOD AND SYSTEM OF DISPLAYING AN ACCIDENT TYPE” filed on Oct. 2, 2001;

U.S. Patent Application Publication No. 2002-0059097 published on May 16, 2002 to Wahlbin et al., entitled “COMPUTERIZED METHOD AND SYSTEM OF ASSIGNING AN ABSOLUTE LIABILITY VALUE FOR AN ACCIDENT” filed on Oct. 2, 2001;

U.S. Patent Application Publication No. 2002-0059086 published on May 16, 2002 to Wahlbin et al., entitled “COMPUTERIZED METHOD AND SYSTEM OF DISPLAYING A ROADWAY CONFIGURATION RELATING TO AN ACCIDENT” filed on Oct. 2, 2001;

U.S. Patent Application Publication No. 2002-0059087 published on May 16, 2002 to Wahlbin et al., entitled “: COMPUTERIZED METHOD AND SYSTEM OF DISPLAYING AN IMPACT POINT RELATING TO AN ACCIDENT” filed on Oct. 2, 2001;

U.S. Patent Application Publication No. 2002-0059083 published on May 16, 2002 to Wahlbin et al., entitled “COMPUTERIZED METHOD AND SYSTEM OF DETERMINING INCONSISTENCIES IN WITNESS STATEMENTS RELATING TO AN ACCIDENT” filed on Oct. 2, 2001;

U.S. Patent Application Publication No. 2002-0049619 published on Apr. 25, 2002 to Wahlbin et al., entitled “COMPUTERIZED METHOD AND SYSTEM OF IDENTIFYING A CREDIBLE WITNESS STATEMENT RELATING TO AN ACCIDENT” filed on Oct. 2, 2001;

U.S. Patent Application Publication No. 2002-0059085 published on May 16, 2002 to Wahlbin et al., entitled “COMPUTERIZED METHOD AND SYSTEM OF DETERMINING A CREDIBLE REAL SET OF CHARACTERISTICS FOR AN ACCIDENT” filed on Oct. 2, 2001;

U.S. patent application Ser. No. 10/306,864 to Wahlbin et al., entitled “COMPUTERIZED METHOD AND SYSTEM FOR ESTIMATING LIABILITY FOR AN ACCIDENT FROM AN INVESTIGATION OF THE ACCIDENT” filed on Nov. 27, 2002;

U.S. patent application Ser. No. 10/306,873 to Wahlbin et al., entitled “COMPUTERIZED METHOD AND SYSTEM FOR ESTIMATING LIABILITY FOR AN ACCIDENT USING DYNAMIC GENERATION OF QUESTIONS” filed on Nov. 27, 2002;

U.S. patent application Ser. No. 10/306,909 to Wahlbin et al., entitled “COMPUTERIZED METHOD AND SYSTEM FOR ESTIMATING AN EFFECT ON LIABILITY OF THE SPEED OF VEHICLES IN AN ACCIDENT AND TIME AND DISTANCE TRAVELED BY THE VEHICLES” filed on Nov. 27, 2002;

U.S. patent application Ser. No. 10/306,623 to Wahlbin et al., entitled “COMPUTERIZED METHOD AND SYSTEM FOR ESTIMATING AN EFFECT ON LIABILITY USING A COMPARISON OF THE ACTUAL SPEED OF VEHICLES IN AN ACCIDENT AND TIME AND DISTANCE TRAVELED BY THE VEHICLES IN A MERGING VEHICLE ACCIDENT” filed on Nov. 27, 2002;

U.S. patent application Ser. No. 10/306,803 to Wahlbin et al., entitled “COMPUTERIZED METHOD AND SYSTEM FOR ESTIMATING AN EFFECT ON LIABILITY USING A COMPARISON OF THE ACTUAL SPEED OF VEHICLES WITH A SPECIFIED SPEED” filed on Nov. 27, 2002;

U.S. patent application Ser. No. 10/306,908 to Wahlbin et al., entitled “COMPUTERIZED METHOD AND SYSTEM FOR ESTIMATING AN EFFECT ON LIABILITY BASED ON THE STOPPING DISTANCE OF VEHICLES” filed on Nov. 27, 2002;

U.S. patent application Ser. No. 10/306,804 to Wahlbin et al., entitled “COMPUTERIZED METHOD AND SYSTEM FOR ESTIMATING AN EFFECT ON LIABILITY USING CLAIM DATA ACCESSED FROM CLAIM REPORTING SOFTWARE” filed on Nov. 27, 2002;

U.S. patent application Ser. No. 10/306,866 to Wahlbin et al., entitled “COMPUTERIZED METHOD AND SYSTEM FOR CREATING PRE-CONFIGURED CLAIM REPORTS INCLUDING LIABILITY IN AN ACCIDENT ESTIMATED USING A COMPUTER SYSTEM” filed on November 27, 2002;

U.S. patent application Ser. No. 10/306,858 to Wahlbin et al., entitled “COMPUTERIZED METHOD AND SYSTEM FOR ESTIMATING LIABILITY USING RECORDED VEHICLE DATA” filed on Nov. 27, 2002;

U.S. patent application Ser. No. 10/306,628 to Wahlbin et al., entitled “COMPUTERIZED METHOD AND SYSTEM FOR ESTIMATING MONETARY DAMAGES DUE TO INJURIES IN AN ACCIDENT FROM LIABILITY ESTIMATED USING A COMPUTER SYSTEM” filed on Nov. 27, 2002;

U.S. patent application Ser. No. 10/790,632 to Woods et al., entitled “SYSTEMS AND METHODS FOR A GRAPHICAL INPUT DISPLAY IN AN INSURANCE PROCESSING SYSTEM” filed on Mar. 1, 2004;

U.S. patent application Ser. No. 10/306,864 to Lorenz, entitled “SYSTEMS AND METHODS FOR USING DATA STRUCTURE LANGUAGE IN WEB SERVICES” filed on Mar. 1, 2004; and

U.S. patent application Ser. No. 10/786,572 to Osborne, entitled “SYSTEMS AND METHODS FOR PRINTING AN INSURANCE DOCUMENT” filed on Feb. 25, 2004 1, 2004.

A knowledge-based system for insurance claim processing may be accessed over the Internet or through a web browser and may provide a web-enabled method and system for processing insurance claims. The insurance claim processing system may include a rules engine and a web server which is coupled to the rules engine. The rules engine may be configured to generate a plurality of insurance claim assessment questions. The web server may be configured to generate a plurality of web pages comprising the insurance claim assessment questions. The insurance claim processing system may further include a web browser which is configured to receive the plurality of web pages comprising the insurance claim assessment questions from the web server. The web browser may then be configured to display the plurality of web pages comprising the insurance claim assessment questions. The web browser may then be configured to receive insurance claim assessment data entered by a user in response to the insurance claim assessment questions during an insurance claim consultation session and send the insurance claim assessment data to the web server. In one embodiment, the web server is further configured to receive the insurance claim assessment data from the web browser and send the insurance claim assessment data to the rules engine.

The rules engine may be further configured to estimate a value of an insurance claim as a function of the insurance claim assessment data. The insurance claim may include a bodily injury insurance claim, and the insurance claim assessment data may include one or more bodily injuries and one or more treatments. The rules engine may be further configured to send the estimate of the value of the insurance claim to the web browser through the web server. The web browser may be further configured to display the estimate of the value of the insurance claim received from the rules engine through the web server. In one embodiment, the web server and web browser are located on separate computer systems which are communicatively coupled through a network. In another embodiment, the web server and web browser may be located and executed on a single computer system.

The insurance claim processing system may further include adapter software which is configured to enable communication between the rules engine and the web server. The adapter software may include one or more dynamic link libraries.

In one embodiment, the insurance claim processing system may further include a plurality of web browsers corresponding respectively to a plurality of users. Each of the web browsers may be configured to receive one or more of the plurality of web pages comprising the insurance claim assessment questions from the web server, display the received web pages comprising the insurance claim assessment questions, receive insurance claim assessment data entered by one of a plurality of users in response to the insurance claim assessment questions during one of a plurality of insurance claim consultation sessions, and send the insurance claim assessment data to the web server.

In one embodiment, a method for developing a web-enabled insurance claims processing system may include providing a rules engine. The rules engine maybe configured to estimate a value of an insurance claim as a function of insurance claim assessment data entered by a user in response to insurance claim assessment questions. The method may further include providing a web server which is configured to generate a plurality of web pages which are viewable by a web browser. The method may further include wrapping the rules engine with a component interface in accordance with a component architecture specification. The component interface may include one or more definitions of methods of communication between the rules engine and the web server, wherein the methods of communication are operable to transmit the insurance claim assessment data from the web server to the rules engine and operable to transmit the insurance claim assessment questions from the rules engine to the web server. The insurance claim assessment data may include one or more bodily injuries and one or more treatments of the bodily injuries. The component architecture specification may include a Component Object Model (COM) specification.

In some embodiments, a user may interact with an insurance claim processing system through the Internet. Users may also communicate with an insurance claim processing system through other networks. In some embodiments, a data structure language (e.g., XML, Web Service Description Language (WSDL), and/or other markup languages (e.g., hyper text markup language (HTML)) may be used for communications between a user and an insurance claim processing system. In some embodiments, WSDL may define an interface for a web service including available operations, the protocol that the user should use to invoke the web service, and the type of data the web service expects.

In one embodiment, a user system may be used to access insurance policies. An insurance policy may include, but is not limited to, automobile insurance, workman's compensation insurance, life insurance, annuities, property insurance, liability insurance, malpractice insurance, and/or commercial package polices. An insurance policy may be issued to at least one entity, such as a corporation, a limited liability company, a limited liability partnership, a limited partnership, a general partnership, a sole proprietorship, or an individual. An insurance policy may include an identifier. An identifier for an insurance claim, policy, or transaction may include, but is not limited to, a policy name and/or number, an entity name and/or number, a user entered name and/or number, a randomly generated number, a number generated by an algorithm on the insurance claim processing system, a picture and/or image, or any combination thereof. Insurance policies may be stored in the insurance claim processing system.

A user system may allow a user to access the Internet. In certain embodiments, a user system may access insurance claims and policies via the Internet. A user system may be capable of browsing while accessing insurance policies. A user may use the Internet to access information about vehicles, premiums, entities and/or federal regulations and rules. Often a user may use information on the Internet in drafting insurance policies and/or determining vehicle history information, annuity payouts, insurance premium rates, and/or government regulations. Information contained on a website or web page may change periodically. A user may desire to capture an image of a website relied on for reference at a later date. A user may capture an image of a web page to capture a substantially similar representation of the website. In an embodiment, during an audit it may be desirable for an individual to view the images of regulated premium rates and/or premium rates in the market relied on by a user in calculating insurance premiums. It may be desirable to recall the history of a vehicle used to calculate premium rates when a claim is later filed on a policy. A user or auditor may be facilitated in reviewing terms of an insurance claim or policy by viewing premium rates obtained the day the policy was issued. It may be desirable to view a vehicle history report at the time an automobile insurance policy was issued at a later date.

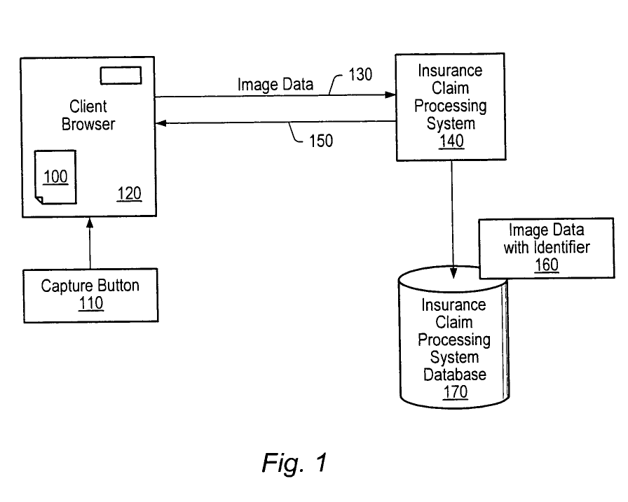

As shown in FIG. 1, a user may be able to capture an image of a website and transmit the image to a server of an insurance claim processing system for later use. A user may access insurance claims and/or policies through the Internet. A user may view a website in a window of a web browser. The website may provide access to an insurance claim or policy 100. A web browser may allow a user to view an insurance claim or policy and the Internet. A web browser may include a dialog box or a section of the web browser that provides information about an insurance claim or policy, such as policy number, policyholder name, policy history, etc. A web browser may include a dialog box or a section of the web browser with links to documents and/or images associated with the insurance claim or policy. A web browser may include a viewable section. In certain embodiments, when a user selects a link from the section of the web browser containing links to documents, the document may be viewed in the viewable section of the browser. In one embodiment, a dialog box containing information about an insurance claim or policy may include links to websites and/or a portion where a web address may be entered. The website entered or selected may be viewable in the viewable section of the web browser. A dialog box containing links to documents may include links to websites and/or a portion where a web address may be entered. The website entered or selected may be viewable in the viewable section of the web browser. In an embodiment, only one insurance policy or claim may be accessed at a given time.

In some circumstances, a user may desire to retain a copy of a website used in an insurance policy or claim. A user may click a capture button 110 on a web browser 120 on a user system to capture an image of a website. The image may be linked to an identifier. The image data of the snap shot and the identifier may be transmitted 130 to a server of an insurance claim processing system 140. A server may transmit a confirmation signal to user system to confirm receipt of the image 150. A server may store image data and an identifier 160 in a repository or database of an insurance claim processing system 170.

A user system may include an image capturing program configured to capture an image of a website. An image, in the context of this application, refers to creating a duplicate, a copy, a replica, a likeness, a reproduction, a representation, a similar image, and/or an impression or view of something permanent or transitory. In an embodiment, an image capturing program is a short application program (commonly referred to as an “applet”). The image capturing program may be written in any programming language including JAVA or C++.

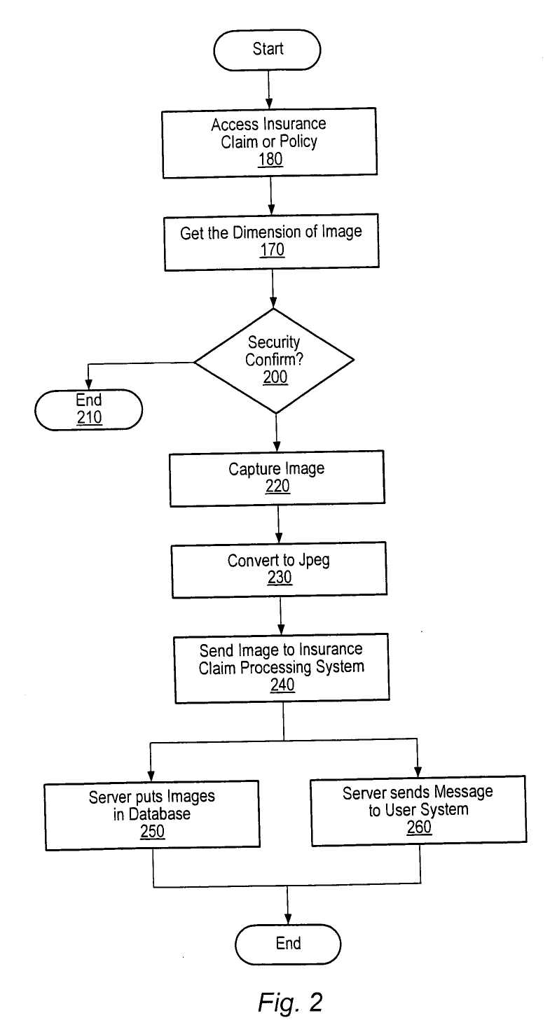

FIG. 2 depicts a flowchart of an embodiment of a method of capturing an image of a website. A user may access an insurance policy via the Internet 180. First, the image capturing program obtains the dimensions of a web page 190. A web browser on the user system may include a prompt to verify that the user is only copying a website in a not harmful and/or not illegal manner 200. A confirmation from the user may be required to proceed with the image capturing program to capture an image. If a user does not confirm the not harmful nature of the copying, the image capturing program may end 210. An entire web page may not fit in the window of an Internet browser.

Often an Internet browser has horizontal and/or vertical scroll bars to view an entire web page. An image capturing program may be configured to capture an image beyond a viewable window of an Internet browser. A print screen function on a computer may only be able print the image actually viewable in the browser window, and unlike the image capturing program which may be able to capture an entire image of a web page. The image capturing program may be configured to obtain dimensions of an entire web page or dimensions of a viewable window shown in an Internet browser window. Image capturing program may then obtain an image of the website 220. Image capturing program may be on the user system. In an embodiment, the image capturing program may be stored in an insurance claim processing system and at least partially run on a user system. An image capturing program may be configured to obtain a pixel by pixel representation of the entire image within the obtained dimensions of the web page. Obtaining a pixel by pixel representation may include the image capturing program copying the color and/or brightness of each pixel of a website image. Image capturing program may obtain an image by copying the brightness and/or color of some of the pixels of a website image. In an embodiment, an image of a website may be captured by reproducing similar pixels of a website in an image file.

Image capturing program may insert a border, logo, icon, image, and/or text in each image. Image capturing program may create a border at least partially around the image of the website captured by the image capturing program. Border may include a date, time, user name, policy number, policyholder, website address, and/or other images such as logos. Image capturing program may be configured to insert a date, time, user name, policy number, policyholder, and/or website address into the image. For example, image capturing program may insert a date in an area on the image created by the image. Image capturing program may be configured to obtain an image of the website by scanning the website. Image capturing program may then convert the image into an image format such as jpg, .pdf, tiff, bitmap or other image file. In an embodiment, image capturing program converts the image to a jpg image file 230. In certain embodiments, image may not be an exact copy of the website. An image may be substantially similar to a website. An image may be substantially similar to the website and have additional text and/or images inserted in by image capturing program. After the image is converted to an image file, the image may be sent to a server in an insurance claim processing system 240. A server may store an image in a database of an insurance claim processing system 250. A server may send a user system a message confirming receipt and/or storage of an image 260. Commonly, print screen functions and programs to save images in the prior art require a user to manually save a file in a location. The image capturing program may, however, automatically save an image, link the image with one or more identifiers, and/or transmit the image to an insurance claim processing system memory. By storing an image in an insurance claim processing system, a user may access the transmitted image from any computer and not only the user system the image was captured on.

In some embodiments, capturing an image capturing may include clicking an icon or button on a toolbar, such as an icon labeled “Image,” “Take Snap,” or “Capture Image.” Capturing an image may include selecting a command, such as a command labeled “Image,” “Take Snap,” or “Capture Image” from a toolbar. An icon or button may be located on a navigation bar or toolbar on a web browser. Clicking an icon or a button or selecting a command from a toolbar may cause an image capturing program on the user system or a server (e.g., an insurance claim processing system server) to run. The image capturing program may capture a representation of the image on a website. The captured image may include portions of a website not visible in a widow of a browser, but accessible in the widow using horizontal or vertical scroll bars to navigate through the web page.

In an embodiment, the image capturing program may run when a link or icon in a section of a web browser is selected or click. The image capturing program may not be user or client based. Many programs to save images in the prior art are client based applications. The image capturing program may be accessible through the insurance claim processing system. An advantage to a non-client based application may be that upgrades may be performed globally on the insurance claim processing system. Each client or user may not need to individually upgrade an image capturing program located on the user system. The link or icon for the image capturing program may be positioned in a section of the browser associated with the insurance claim processing system graphical interface, such as a section of the graphical interface that includes a policy number. An advantage of accessing the image capturing program through a graphical interface of an insurance claim processing system that is in a web browser may be a user's access may increase. A user may not need to download or install additional software on the user system to operate the image capturing program. By accessing the image capturing program through a web browser linked to an insurance claim processing system, a user may access the image capturing program from any computer that has access to the Internet. A further advantage may be when images are stored on a database of an insurance claim processing system, the images may be accessible from multiple locations or from any computer connected to the Internet.

User system may link the image to an identifier. Image capturing program may automatically link the image to an identifier. A user system may concurrently link an image with more than one identifier such as a policy number and policyholder. The image may be linked to an identifier associated with an insurance policy a user is currently accessing. The user may be prompted prior to linking an image with an identifier to confirm appropriate linkage. A user may be prompted to enter one or more identifiers to be associated with the image. In an embodiment, a user system may transmit an image with an identifier including a user system number. An insurance claim processing system may use a user system number to link an image with one or more other identifiers such as a policy name, a policy number. When a server of an insurance claim processing system stores an image, the image may be linked to identifiers generated by the server and not the identifiers transmitted by the user system.

In certain embodiments, an image may be automatically linked with one or more identifiers. An image capturing program may automatically link the captured image to one or more identifiers and/or automatically transmit the image to an insurance claim processing system for store in a memory of the insurance claim processing system. If a user ran an image capture program located on the user system, the user would have to manually enter a file name and a storage location. For example, a user may access an insurance policy or claim through a web browser on the user system. In an embodiment, a user may only be able to access one insurance policy or claim at a time. A user may access the Internet through the web browser. A link on web browser may direct a viewable window in a browser to a web address or a user may enter a web address to view. In one embodiment, a user may not enter the web address the user seeks to access in the toolbar of the web browser, but rather in a field associated with a graphical interface the insurance claim processing system. When a user accesses a website, the user may capture an image of the website using an image capturing program at least partially running on the user system. The image capturing program may automatically link the captured image to one or more identifiers associated with the insurance claim or policy the user is currently accessing. In one embodiment, the image capturing program may automatically link the image of the website to the policy number and policyholder name of the insurance policy the user is concurrently accessing. When an image is linked to more than one identifier, it may facilitate location of relevant documents. For example, if an image is only stored under a file name it may only be recalled by the file name. When an image is linked to multiple identifiers, a single image may be recalled by accessing any of a plurality of documents or by querying any of several identifiers. This may be advantageous to auditors or other users seeking complete information about a policy or policyholder.

A user may save an image on the user system. A user may email or transmit the image to another user and/or an insurance claim processing system. A user may delete an image from the user system or the insurance claim processing system. A user may print an image. A user may print an image with one or more associated or linked identifiers.

In some embodiments, a user system may transmit an image to an insurance claim processing system. An identifier associated with an image may be transmitted to an insurance claim processing system. A user system may transmit an image via the Internet, a WAN, or a LAN. In certain embodiments, a user system may be directly coupled to an insurance claim processing system.

An insurance claim processing system may categorize a transmitted image with an existing entry or a new entry in a database. Insurance claim processing system may include a database or repository. Images transmitted to an insurance claim processing system may be stored on a database. Data including images in a database may be categorized. Data may be categorized according to identifiers and/or user entered parameters. In some embodiments, an insurance claim processing system includes a database with documents associated with one or more identifiers. Each document may be recalled or access by one or more of the identifiers. Data in the database may be categorized by the identifiers. As new documents are added to the database, they may be associated with the existing identifiers that are the same or similar to identifiers transmitted with the new document. An insurance claim processing may categorize a transmitted image with an existing entry or a new entry in a database. For example, a database of an insurance claim processing system may include an insurance policy. Data in the database may include policy number, policyholder name, and/or type of coverage under the policy. As lines of coverage are entered into a database, they may be associated with a policyholder name that already exists in a database. In one embodiment, an image of a vehicle history report linked to a policyholder name may be transmitted to a financial service organization system. The financial service organization system may store and associate the image of the vehicle history report with previously existing entries associated with the policyholder name. Unlike with print screen functions, an insurance claim processing system may automatically store and associate images or images with previously existing data in a database.

An image and an identifier associated with the image may be stored in a database. One or more identifiers may be used to recall an image from a database. In certain embodiments, an identifier may be associated with more than one image. The identifier may be used to recall all images associated with the identifier. In an embodiment, more than one identifier may be associated with an image. The image may be recalled using a single identifier or any combination of the identifiers associated with the image. An image may be recalled when data also associated with a same identifier as the image is accessed (e.g., when an insurance policy document is accessed, all images associated with that insurance policy number and/or name also may be recalled).

In some embodiments, an identifier may be a date. A user may recall all images in a date range using the identifier in a query of a database where the images are stored. By recalling all images in a date range, a user may be able to ascertain workman's compensation premiums and/or federal regulations in a given time period. Since a user may recall images in a date range, if an insurance policy is missing an image of regulated insurance premium rates an image corresponding to a similar date period may be recalled to obtain the needed or missing information.

An image capturing program on the user system may transmit an image to an insurance claim processing system. A user may be required to prompt transmission of an image to an insurance claim processing system. An image capturing program may automatically transmit an image to an insurance claim processing system.

User system may be configured to transmit an image to an insurance claim processing system. An image capturing program at least partially running on user system may be configured to automatically transmit a copy of the image to an insurance claim processing system. The image capturing program may create a prompt displayed on the user system. The prompt may inquire whether the user would like to send an image to an insurance processing system. In an embodiment, a user may manually click a button on the web browser or select a command for the image to be transferred to the insurance claim processing system.

An insurance claim processing system may be configured to receive images transmitted by a user system. An insurance claim processing system may include an image storage program. The image storage program may be a short application program or subroutine configured to receive and store images. Image storage program may be written in any programming language including JAVA or C++. Image storage program may be designed to receive transmitted images and/or identifiers. Image storage program may transmit a message to a user system to confirm receipt and/or storage of an image. The image storage program may automatically transmit one or more messages to a user system when the user system transmits an image to the insurance claim processing system. A message sent to user system may include a location of an image in a database. Image storage program may store transmitted images in a memory, database, or repository. In an embodiment, image storage program receives images transmitted from a user system and stores them in a database such that the image may be retrieved from a database using one or more of the identifiers associated with the image. Image storage program may transmit images into a database such as a document manager. A document manager may integrate with various software systems; provide instant access to files; consolidate documents from multiple sources into a single view; substantially reduce printing, assembling and mailing costs associated with documents; and improve efficiency of network and computing resources. Incorporating images into a document manager may allow a user to view a variety of documents including one or more images in a single view.

An image may be transmitted with one or more identifiers. In an embodiment, an image storage program of an insurance claim processing system may include automatically linking an image to an identifier. Automatically linking a snapshot with an identifier may reduce the likelihood that a snapshot is incorrectly associated with an identifier (e.g., when a user must enter a file name or number, the user may enter the wrong name or number and cause the image to be lost or become incorrectly linked to a different insurance policy). An image may be transmitted with an identifier including, but not limited to, user name and/or number, user system name and/or number, and node number. An insurance claim processing system may use the identifier number associated with the user or user system to automatically generate one or more additional identifiers such as policy number and/or policyholder. An insurance claim processing system may automatically generate identifiers based on policies accessed by a user (e.g., last policy accessed by the user system, last policy created by insurance claim processing system for user system).

An insurance claim processing system may store images on a memory. A memory may include an installation medium (e.g., a CD-ROM or floppy disks, a computer system memory such as DRAM, SRAM, EDO RAM, Rambus RAM, etc.) or a non-volatile memory such as a magnetic media (e.g., a hard drive or optical storage). Memory may also include other types of memory or combinations thereof. An insurance claim processing system may store images in a database of an insurance claim processing system.

An insurance claim processing system may include a dynamic database packageset switching system configured to allow user systems to access images and/or documents in database through a variety of different software applications. Using a dynamic database packageset switching system may allow a user on user system to access images when parameters (e.g., policy type, policyholder, etc.) are associated with a different identifier than the identifier used for the same parameter in the software application that originally transmitted the image to the database.

In an embodiment, a user may capture images of a vehicle history. When accessing a policy, a first user may view documents or links to documents such as images of a vehicle's history, an automobile insurance policy, and/or claims filed by second user on a different software application than first user. By storing captured images in a document manager, a user accessing information on an insurance claim processing system may have access to numerous documents.

Security software and restrictions may restrict a user's ability to copy images on a website. Images and/or text on a web page may be encrypted to restrict image copying. In some embodiments, a user may desire to capture an image of a website with security software/restrictions and/or encryption. An image capturing program may be configured to allow copying of such websites. An image capturing program may prompt a user to certify that the user is attempting to copy a website not owned by the user and that the copying is not harmful and/or not illegal. For example, when a user clicks the “Capture Image” button on user's browser, a pop-up box may require a user to “Agree” or “Disagree” that user is attempting to copy a website the user does not own but that such copying is not harmful. A prompt to certify not harmful and/or not illegal copying may be transmitted to a user's web browser so that the web browser allows an image of the website to be captured.

In some embodiments, an insurance claim processing system may recall one or more images. An insurance claim processing system may recall one or more images associated with one or more identifiers when a user system prompts an insurance claim processing system to recall an insurance policy. A user system may recall an image using one or more identifiers. A user system may transmit identifiers to an insurance claim processing system. An insurance claim processing system may recall all images associated or linked with the transmitted identifiers and transmit all or at least a portion of the images to the user system.

In certain embodiment, an insurance claim processing system may automatically recall all or at least one image linked to one or more identifiers associated with an insurance policy and/or claim when a user system accesses the insurance policy. An insurance claim processing system may automatically recall all or at least one image associated with an insurance policy and/or claim held by a policyholder when a user system accesses the policyholder's records.

In an embodiment, a user may access an insurance policy stored on an insurance claim processing system through the Internet. Internet web browsers may include, but are not limited to, Internet Explorer or Netscape. An insurance claim processing system may recall a stored policy, transmit a policy, and/or transmit at least some information about images associated with a policy (e.g., names of images associated with a policy, creation dates of images associated with a policy, and/or links configured to recall images). When an insurance policy is displayed in a window of a web browser, hyperlinked text and/or toolbars may be available. Images associated with an insurance policy may be displayed on a web browser as hyperlinked text. When a user clicks on hyperlinked text, an image associated with the hyperlinked text may be recalled from an insurance claim processing system, transmitted to the user system, and displayed on the user system. A user may print or save a copy of the image on the user system.

In some embodiments, insurance claim processing system may be configured to receive one or more transmitted images from one or more user systems. An identifier may be transmitted with the image. In an embodiment, insurance claim processing system automatically associates an image with at least one identifier. For example, an insurance claim processing system may automatically associate an image with an automobile insurance policy a user system is currently accessing or the last automobile insurance policy a user system accessed. A user system may transmit an image and one or more identifiers such as policy number, policy name, policyholder, and/or user name to an insurance claim processing system. Insurance claim processing system may store an image and one or more identifiers in a memory or database. When a user system requests an automobile insurance policy at a later date, insurance clam processing system may recall images associated with the automobile insurance policy using the identifiers stored in the database or a memory. A user system may be able to recall all images associated with a policyholder through the insurance claim processing system. Insurance claim processing system may automatically recall and transmit to a user system at least some of the images associated with an identifier when a user system recalls an automobile policy, files a claim, and/or adds additional lines of coverage to an existing policy. For example, an insurance claim processing system may automatically recall and transmit to a user system all the images (e.g., VIN checks, etc.) associated with a particular automobile insurance policy or policyholder accessed by the user system.

In some embodiments, a user system may access an automobile insurance policy. The automobile insurance policy may be stored in a memory or database in an insurance claim processing system. A user may want a vehicle history report or to perform a VIN check on a car listed in the automobile insurance policy or before the car is listed on the automobile insurance policy. A user may use the Internet to obtain a vehicle history report. A user may take an image of the vehicle history report. It may be desirable to capture an image of the vehicle history report because information on web pages may be transient. Web addresses may change and information on the pages may change as well. To ensure recollection of the information used to draft an automobile insurance policy, it may be desirable to capture an image of the web page at a given time so that the contents of a web page may be recalled at a later date for auditing purposes or other reasons.

An image capturing program at least partially running on the user system may capture an image of the website containing the vehicle history report. The image may be a substantially similar copy of the website. In an embodiment, image capturing program may create a border at least partially around the image of the website captured by the image capturing program. Border may include a date, time, user name, policy number, policyholder, website address, and/or other images such as logos.

In some embodiments, a user may be drafting a workman's compensation insurance policy. A user may use the user system to create a new workman's compensation insurance policy. A u system may access insurance claim processing system to draft or open a workman's compensation insurance policy. Workman's compensation insurance premiums may be regulated. The National Counsel on Compensation Insurance (“NCCI”) often may list the allowed premium rates. A user may desire access to NCCI's website in order to obtain an appropriate premium rate for the workman's compensation insurance policy the user is creating. A user may capture an image of the website listing the rates. An image may be associated with the policy by an identifier including, but not limited to, policy number, policyholder's name, and/or date. An image capturing program may insert a date and a time and/or a policy number in the image captured as the image. An image and one or more identifiers may be transmitted to the insurance claim processing system. Insurance claim processing system may store an image and one or more identifiers in a memory or database. Often insurance policies are audited. Since websites often change, especially when premium rates are updated, by capturing an image of the website with the current rates for workman's compensation premiums proximate a day the policy is created, the information used to draft a policy may be obtained without relying on a user's memory. Insurance claim processing system may automatically recall and transmit to a user system at least some of the images associated with an identifier when a user system recalls an insurance policy, when a user enters a claim filed by a policyholder, or when a user issues a claim check. For example, insurance claim processing systems may automatically recall and transmit to a user system all the images (e.g., NCCI website containing interest rates) associated with a particular workman's compensation insurance policy accessed by the user system.

In certain embodiments, insurance policies such as life insurance and/or annuities may be dependent on various parameters specific to a policyholder. An insurance claim processing system may store templates which draft policies and/or calculate premium rates. A user may access a life insurance policy template on an insurance claim processing system through the Internet. A user may enter parameters such as name, date of birth, health, blood pressure, and/or occupation in fields on the template. A template may then automatically draft a policy and calculate a policy premium. It may be desirable to capture an image of a template with entered parameters. By capturing an image of a template, a record may be kept of the factors or parameters used to draft a policy and calculate an appropriate premium. Using the “Save As” feature common on web pages may not be adequate because the “Save As” feature may not save parameters entered in a template on a web page. At a later time, during audits, reviews, and/or updates of policies, and/or claim processing, the parameters used to generate a policy may be easily discovered by recalling images associated with the insurance policy. Insurance claim processing system may automatically recall and transmit to a user system at least some of the images associated with an identifier when a user system recalls an insurance policy. For example, an insurance claim processing system may automatically recall and transmit to a user system all the images associated with a particular insurance policy accessed by the user system (i.e., images of parameters entered when calculating premiums, federal interest rates, common interest rates in the market, etc.). Similarly, the described methods may be used with any type of insurance policy, insurance policy claim, or insurance transaction.

In one embodiment, a user may capture images of websites containing information considered prior to granting an insurance policy such as vehicle histories, credit reports, and/or health records. A user may also capture images of web based templates after parameters are entered into various fields. A web based template may be used to calculate premiums and/or generate policies. Images may be transmitted to insurance claim processing system with one or more identifiers. Identifiers may include policy name and/or number (i.e., automobile insurance, 00-997428). Insurance claim processing system may store images and identifiers in a memory or database. Storing images on a database associated with a policy number and/or policyholder may aid insurance underwriters. Images may allow insurance underwriters to view all information considered in granting an insurance policy and the parameters entered in a template to draft an insurance policy and/or calculate premium rates.

In certain embodiments, the user system may be coupled to an insurance claim processing system through a network (e.g., direct couple to other computers, WAN, LAN, the Internet, and/or combinations thereof). A user system may include a CPU and/or a memory. A memory may be coupled to the CPU. The user system memory may store program instructions. In an embodiment, program instructions may be at least partially executed by the CPU of the user system. The program instructions may include requesting an insurance claim or policy through a web browser. The insurance policy may be stored on a memory of the insurance claim processing system. The web browser may provide access to an insurance policy stored in a memory or a database of an insurance claim processing system. The user system may then access a website through the web browser. A user may type a web address in a field of a section of the web browser generated by the insurance claim processing system. A user may select a link to a web address in a field of a section of the web browser generated by the insurance claim processing system. In some embodiments, a web browser may be configured such that in a viewable window a user may access the Internet while viewing links to documents associated with a policy in another section of the browser.

A user may desire to capture an image of the website. In an embodiment, program instructions may include capturing the image of the website through the web browser. In an embodiment, an icon or command associated with an image capturing program on the insurance claim processing system may be positioned in a section of the web browser generated by the insurance claim processing system. When a user selects the icon or the command, the image capturing program may at least partially run on the user system. The program instructions may include automatically linking the image to one or more identifiers. The program instructions may include transmitting an image and/or one or more identifiers to an insurance claim processing system.

In one embodiment, an insurance claim processing system may include a CPU and a memory coupled to the CPU. The insurance claim processing system memory may store programs that may be at least partially executed by the CPU of the insurance claim processing system. The program instructions may include receiving the image from the user system. The program instructions may include storing the image and one or more identifiers in a memory of the insurance claim processing system. The program instructions may include transmitting or sending a message to the user after receiving the image and/or identifiers. The message may confirm receipt of the image and/or transmit a location of the image on the insurance claim processing system.

In some embodiments, managing insurance claims and policies may include accessing an insurance policy through a user system across a network via one or more Internet protocols (e.g., TCP/IP, HTTP). A user may access an insurance policy through a web browser. The insurance policy may be stored on an insurance claim processing system. A user may access insurance policies stored on the insurance claim processing system via the web browser. A user may access a website across the network via one or more Internet protocols. A user may access a website through the same web browser the user accessed the insurance claim or policy. In an embodiment, a user system may only access one insurance claim and/or policy at a time. A user system may capture an image of the website and link the image to one or more identifiers. A user system may link the captured image with an identifier associated with the accessed insurance claim or policy. A user system may transmit the image to the insurance claim processing system across a network via one or more Internet protocols. An insurance claim processing system may receive the image and store the image and one or more identifiers in a memory of the insurance claim processing system.

In certain embodiments, a system for managing insurance claims and policies may include a carrier medium with program instructions. The program instructions may include transmitting an insurance claim or policy to a user system across a network via one or more Internet protocols when a user requests the insurance claim or policy. A user may also access a website across a network via one or more Internet protocols. A user may first access an insurance claim or policy and then search websites. A user may desired to save an image of a website used, for example, to create a policy and/or determine a premium. Program instructions may include capturing an image of the accessed website. The program instructions may include automatically linking the image to one or more identifiers. The image may be linked to the policy number of the insurance claim or policy the user last viewed. In an embodiment, the program instructions may include transmitting the image across a network via one or more Internet protocols to the insurance claim processing system from the user system. The program instructions may include storing the image and one or more identifiers in a memory of the insurance claim processing system. In one embodiment, program instructions may include sending a message to a user system after receiving the image. The message may indicate that the image was successfully sent and/or received. The message may indicate the different identifiers to which the image is linked.

In certain embodiments, capturing an image of an error message may aid a user in obtaining technical support. A user may access an insurance policy, application, or transaction through a web based interface. The web based interface may allow an insurance claim processing system to transmit information, files, or other data to a user system and/or run programs on a user system. Sometimes a user may encounter an error when accessing an insurance policy, application, or transaction or running a program from the insurance claim processing system. A user may capture an image of the error message. User may send an image to technical support via the Internet or email. An image of the error message may be linked to an identifier and transmitted to an insurance claim processing system. In an embodiment, an image of an error message may be linked with an identifier including a user name and transmitted to an insurance claim processing system. An insurance claim processing system may store the image linked to a user name in a database. Technical support agents may recall an image of an error message using a user name.

In certain embodiments, technical support agents of an insurance claim processing system may be able to access the insurance policy, application, or transaction and view the image error message. For example, a user may contact technical support and identify the policy number of the insurance policy number the user was working on when an error occurred. Technical support can recall the insurance policy using the policy number. Insurance claim processing system may recall all images associated with the insurance policy number and technical support may view an image of the error message. In an embodiment, user emails image to technical support. By capturing a substantially similar representation of the error message received by a user, technical support may be facilitated. A user may also send an image of error message to other users to obtain advice regarding the error.

Managing Financial Transactions

In some embodiments, a user may access documents such as financial transactions and/or financial transaction templates stored on a server of a financial service organization system through a web browser. A web browser may include more than one section, such as toolbars and icons. When accessing a financial transaction or template through a web browser, a web browser may include at least two sections. At least one section of the web browser includes a viewable window. A viewable window may be able to display documents, financial transactions, loan terms, interest rates, and/or web pages. A section of the web browser may include financial transaction information including, but not limited to, financial transaction number, loan number, borrower name, lender number, history of the transaction, etc. A section of the web browser may include links to documents associated with the financial transaction or template. Features of the described sections may be combined in a single or several sections in a web browser.

In some embodiments, a user may access a website and capture an image or image of the website. An image, in the context of this application, refers to a duplicate, a copy, a replica, a likeness, a reproduction, a representation, a similar image, and/or an impression or view of something permanent or transitory. An image may be linked on the user system or a server of a financial service organization to an identifier associated with an or a financial transaction. An image may be transmitted to and stored in a financial service organization system. A user may recall an image by entering one or more identifiers in the user system. A user may recall an image by recalling data associated with one or more identifiers also associated with an image (e.g., images linked to a borrower name may be recalled by a user when the user recalls all loans held by the borrower, etc.). A user system may transmit the requested identifier to financial service organization system. A financial service organization system may recall the one or more images associated with the identifier.

Financial transactions may be managed between a user system and a financial service organization system. A user system may be coupled to a financial service organization system. Wires, wide area networks (“WAN”), local area networks (“LAN”), and combinations thereof may couple a user system and a financial service organization system. A WAN may be a network that spans a relatively large geographical area. The Internet is an example of WAN. A WAN may include a variety of heterogeneous computer systems and networks that may be interconnected in a variety of ways and that may run a variety of software applications.

One or more LANs may be coupled to a WAN. A LAN may be a network that spans a relatively small area compared to a WAN. A LAN may be confined to a single building or group of buildings. Each node (e.g., user system, individual computer system or device) on a LAN may have its own CPU with which it may execute programs, and each node may also be able to access data and devices anywhere on a LAN. A LAN may allow many users to share devices (e.g., printers) and data stored on file servers. A LAN may be characterized by a variety of types of topology (e.g., the geometric arrangement of devices on the network), of protocols (e.g., the rules and encoding specifications for sending data, and whether the network uses a peer-to-peer or user/server architecture), and of media (e.g., twisted-pair wire, coaxial cables, fiber optic cables, and/or radio waves). A LAN may be coupled to other computer systems and/or other devices and/or other LANs through a WAN.

One or more mainframe computer systems may be coupled to a WAN. A mainframe may be coupled to a storage device or file server and mainframe terminals. A financial service organization system may include a combination of mainframes and/or mainframe terminals. Mainframe terminals may access data stored in the storage device or file server coupled to or included in mainframe computer system. A user system may be a mainframe terminal.

A WAN may also include computer systems (e.g., user systems, financial service organization systems, etc.) connected to a WAN individually and not through a LAN. For example, WAN may include computer systems that may be geographically remote and connected to each other through the Internet.

A computer system (e.g., user systems, financial service organization systems, etc.) may also include a display device such as monitor, an alphanumeric input device such as keyboard, and a directional input device such as mouse. A computer system (e.g., user systems, financial service organization systems, etc.) may typically include components such as CPU with an associated memory such as floppy disks and/or CD-ROMs. Memory may store program instructions for computer programs. Program instructions may be executable by CPU. The term “memory” is intended to include any installation medium, e.g., a CD-ROM or floppy disks, a computer system memory such as DRAM, SRAM, EDO RAM, Rambus RAM, etc., or any non-volatile memory such as a magnetic media, e.g., a hard drive or optical storage. Memory may also include other types of memory or combinations thereof. In addition, memory may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, personal digital assistant (“PDA”), television system or other device. In general, the term “computer system” may refer to any device having a processor that executes instructions from a memory.

Computer system may be operable to execute computer programs to implement computer-implemented systems. It may be desirable to utilize a knowledge-based system for financial transactions which is configured to be accessed over the Internet or through a web browser, such as those described in the following applications, which are fully incorporated herein by reference as if set forth herein:

U.S. patent application Ser. No. 09/603,306 to Wolfe, entitled “SYSTEM AND METHOD FOR DISPLAYING MESSAGES USING A MESSAGES TABLE” filed on Jun. 23, 2000;

U.S. patent application Ser. No. 10/285,292 to Childress et al., entitled “GRAPHICAL DISPLAY OF BUSINESS RULES” filed on Oct. 31, 2002;

U.S. patent application Ser. No. 10/285,289 to Childress et al., entitled “METHOD OF MODIFYING A BUSINESS RULE” filed on Oct. 31, 2002;

U.S. patent application Ser. No. 10/285,339 to Childress et al., entitled “METHOD OF MODIFYING A BUSINESS RULE WHILE TRACKING THE MODIFICATIONS” filed on Oct. 31, 2002;

U.S. patent application Ser. No. 10/285,375 to Childress et al., entitled “METHOD OF FORMING A BUSINESS RULE” filed on Oct. 31, 2002;

U.S. patent application Ser. No. 10/285,338 to Childress et al., entitled “METHOD OF GENERATING A GRAPHICAL DISPLAY OF A BUSINESS RULE WITH A TRANSLATION” filed on Oct. 31, 2002;

U.S. patent application Ser. No. 10/285,293 to Childress et al., entitled “METHOD OF GENERATING A GRAPHICAL DISPLAY OF A BUSINESS RULE AND ASSOCIATED BUSINESS RULE ELEMENTS” filed on Oct. 31, 2002; and

U.S. patent application Ser. No. 10/306,864 to Lorenz, entitled “SYSTEMS AND METHODS FOR USING DATA STRUCTURE LANGUAGE IN WEB SERVICES” filed on Mar. 1, 2004.

A knowledge-based system for financial processing and/or managing may be accessed over the Internet or through a web browser and may provide a web-enabled method and system for processing financial transactions. The financial service organization system may include a rules engine and a web server which is coupled to the rules engine. The rules engine may be configured to generate a plurality of financial transaction assessment questions. The web server may be configured to generate a plurality of web pages comprising the financial transaction assessment questions. The financial service organization system may further include a web browser which is configured to receive the plurality of web pages comprising the financial transaction assessment questions from the web server. The web browser may then be configured to display the plurality of web pages comprising the financial transaction assessment questions. The web browser may then be configured to receive financial transaction data entered by a user in response to the financial transaction assessment questions during a financial transaction session and send the financial transaction data to the web server. In one embodiment, the web server is further configured to receive the financial transaction data from the web browser and send the financial transaction data to the rules engine.

The rules engine may be further configured to calculate financial information, such as principal left on a loan, as a function of the transmitted financial transaction data. The rules engine may be further configured to send the estimate of the calculated financial information to the web browser through the web server. The web browser may be further configured to display the estimate of the calculated financial information received from the rules engine through the web server. In one embodiment, the web server and web browser are located on separate computer systems which are communicatively coupled through a network. In another embodiment, the web server and web browser may be located and executed on a single computer system.

The financial service organization system may further include adapter software which is configured to enable communication between the rules engine and the web server. The adapter software may include one or more dynamic link libraries.

In one embodiment, the financial service organization system may further include a plurality of web browsers corresponding respectively to a plurality of users. Each of the web browsers may be configured to receive one or more of the plurality of web pages comprising the financial transaction questions from the web server, display the received web pages comprising the financial transaction questions, receive financial transaction assessment data entered by one of a plurality of users in response to the financial transaction assessment questions during one of a plurality of financial transaction sessions, and send the financial transaction data to the web server.

In one embodiment, a method for developing a web-enabled financial transaction management system may include providing a rules engine. The method may include providing a web server which is configured to generate a plurality of web pages which are viewable by a web browser. The method may further include wrapping the rules engine with a component interface in accordance with a component architecture specification. The component interface may include one or more definitions of methods of communication between the rules engine and the web server, wherein the methods of communication are operable to transmit the financial transaction assessment data from the web server to the rules engine and operable to transmit the financial transaction assessment questions from the rules engine to the web server. The component architecture specification may include a Component Object Model (COM) specification.

In some embodiments, a user may interact with the financial service organization through the Internet. Users may also communicate with a financial service organization system through other networks. In some embodiments, a data structure language (e.g., XML, Web Service Description Language (WSDL), and/or other markup languages (e.g., hyper text markup language (HTML)) may be used for communications between a user and financial service organization system. In some embodiments, WSDL may define an interface for a web service including available operations, the protocol that the user should use to invoke the web service, and the type of data the web service expects.

In an embodiment, a user system may be used to access financial transactions. Financial transactions may include, but are not limited to, bank account credits/debits; credit card transactions; credit card issuances; and/or loans such as mortgages, home equity loans, personal loans, and/or commercial loans. Financial transactions may include an identifier. An identifier for a financial transaction may include, but is not limited to, a credit card name, a transaction amount and/or range, a creditor name and/or number, a debtor name and/or number, a bank account name and/or number, a loan number, an entity name and/or number, a credit card issuer, a randomly generated number, a number generated by an algorithm on a user system and/or a financial service organization system, a picture and/or an image, a user entered name and/or number, or any combination thereof. Financial transactions may be stored in a financial service organization system.

A user system may allow a user to access the Internet. In certain embodiments, a user system may access financial transactions via the Internet. A user system may be capable of browsing while accessing financial transaction information. A user may use the Internet to access information about credit, interest rates, entities and/or federal regulations and rules. Often a user may use information on the Internet to draft loan applications and/or determine interest rates, encumbrances on collateral, and/or credit scores. Information contained on a website or web page may change periodically. A user may desire to capture an image of a website relied on for reference at a later date. A user may take an image or image of a web page to capture a substantially similar representation of the website. In an embodiment, during an audit it may be desirable for an individual to view the images of interest rates relied on by a user in calculating loan interest rates. It may be desirable to recall the history of a vehicle used to calculate premium rates when a claim is later filed on a policy. A user or auditor may be facilitated in reviewing terms of a loan by viewing market interest rates in an image obtained the day the interest rate was calculated. It may be desirable to view a credit history of a borrower at the time of a loan at a later date.

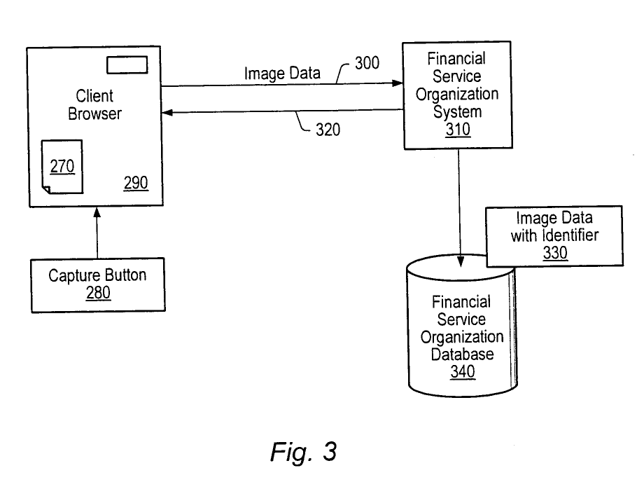

As shown in FIG. 3, a user may be able to capture an image of a website and transmit the image to a server of a financial service organization system for later use. A user may access financial transactions through the Internet. A user may view a website in a window of a web browser. The website may provide access to a financial transaction 270. A web browser may allow a user to view information about a financial transaction and the Internet. A web browser may include a dialog box or a section of the web browser that provides information about a financial transaction, such as transaction number, credit card number, borrower name, etc. A web browser may include a dialog box or a section of the web browser with links to documents and/or images associated with the financial transaction. A web browser may include a viewable section. In certain embodiments, when a user selects a link from the section of the web browser containing links to documents, the document may be viewed in the viewable section of the browser. In one embodiment, a dialog box containing information about a financial transaction may include links to websites and/or a portion where a web address may be entered. The website entered or selected may be viewable in the viewable section of the web browser. A dialog box containing links to documents may include links to websites and/or a portion where a web address may be entered. The website entered or selected may be viewable in the viewable section of the web browser. In an embodiment, only one financial transaction may be accessed at a given time.

In some circumstances, a user may desire to retain a copy of a website used in a financial transaction. A user may click a capture button 280 in a web browser 290 on a user system to capture an image of a website. The image may be linked to an identifier. The image data of the snap shot and the identifier may be transmitted 300 to a server of a financial service organization system 310. A server may transmit a confirmation signal to user system to confirm receipt of the image 320. A server may store image data and an identifier 330 in a repository or database of a financial service organization system 340.

A user system may include an image capturing program configured to capture an image or image of a website. An image, in the context of this application, refers to an image, a duplicate, a copy, a replica, a likeness, a reproduction, a representation, a similar image, and/or an impression or view of something permanent or transitory. In an embodiment, an image capturing program is a short application program (commonly referred to as an “applet”). The image capturing program may be written in any programming language including JAVA or C++.

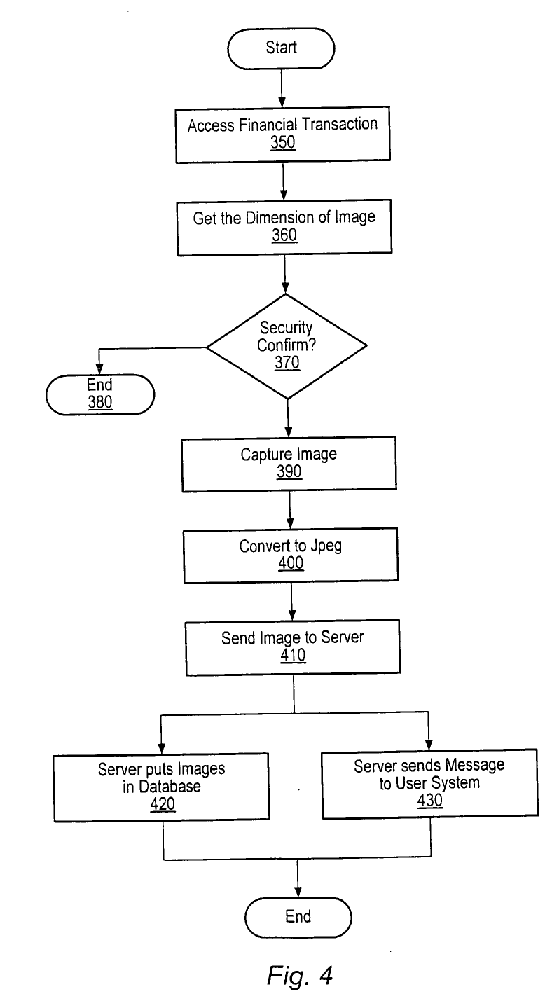

FIG. 4 depicts a flowchart of an embodiment of a method of capturing an image of a website. A user may access a financial transaction via the Internet 350. First, the image capturing program obtains the dimensions of a web page 360. A web browser on the user system may include a prompt to verify that the user is only copying a website in a not harmful and/or not illegal manner 370. A confirmation from the user may be required to proceed with an image capturing program to capture an image. If a user does not confirm the not harmful nature of the copying, the image capturing program may end 380. An entire web page may not fit in the window of an Internet browser.

Often an Internet browser has horizontal and/or vertical scroll bars to view an entire web page. Image capturing program may be configured to capture an image beyond a viewable window of an Internet browser. A print screen function on a computer may only be able print the image actually viewable in the browser window, and unlike an image capturing program which may be able to capture an entire image of a web page. Image capturing program may be configured to obtain dimensions of an entire web page or dimensions of a viewable window shown in an Internet browser window. Image capturing program may then obtain an image of the website 390. Image capturing program may be on the user system. In an embodiment, image capturing program may be stored in a financial service organization system and at least partially run on a user system. Image capturing program may be configured to obtain a pixel by pixel representation of the entire image within the obtained dimensions of the web page. Obtaining a pixel by pixel representation may include the image capturing program copying the color and/or brightness of each pixel of a website image. Image capturing program may obtain an image by copying the brightness and/or color of some of the pixels of a website image. In an embodiment, an image of a website may be captured by reproducing similar pixels of a website in an image file. Commonly, print screen functions and programs to save images in the prior art require a user to manually save a file in a location. The image capturing program may, however, automatically save an image, link the image with one or more identifiers, and/or transmit the image to a financial service organization system memory. By storing an image in a financial service organization system, a user may access the transmitted image from any computer and not only the user system the image was captured on.

Image capturing program may insert a border, logo, icon, image, and/or text in each image. Image capturing program may create a border at least partially around the image of the website captured by the image capturing program. Border may include a date, time, user name and/or number, loan name and/or number, financial transaction number, entity name and/or number, transaction amount, credit card name and/or number, credit card number, borrower name and/or number, website address, and/or other images such as logos. Image capturing program may be configured to insert a date, time, user name, borrower name and/or number, and/or website address into the image. For example, image capturing program may insert a date in an area on the image created by the image. Image capturing program may be configured to obtain an image of the website by scanning the website. Image capturing program may then convert the image into an image format such as .jpg, .pdf, .tiff, bitmap or other image file. In an embodiment, image capturing program converts the image to a jpg image file 400. In certain embodiments, image may not be an exact copy of the website. Image may be substantially similar to the website. Image may be substantially similar to the website and have additional text and/or images inserted in by image capturing program. After the image is converted to an image file, the image may be sent to a server in a financial service organization system 410. A server may store an image or image in a database 420. A server may send a user system a message confirming receipt and/or storage of an image 430.

In some embodiments, capturing an image may include clicking an icon or button on a toolbar, such as an icon labeled “Image,” “Take Snap,” or “Capture Image.” Capturing an image may include selecting a command, such as a command labeled “Image,” “Take Snap,” or “Capture Image” from a toolbar. An icon or button may be located on a navigation bar or toolbar on a web browser. Clicking an icon or a button or selecting a command from a toolbar may cause an image capturing program on the user system or a server (e.g., a financial service organization system server) to run. The image capturing program may capture a representation of the image on a website. The captured image may include portions of a website not visible in a widow of a browser, but accessible in the widow using horizontal or vertical scroll bars to navigate through the web page.

In an embodiment, the image capturing program may run when a link or icon in a section of a web browser is selected or click. The image capturing program may not be user or client based. Many programs to save images in the prior art are client based applications. The image capturing program may be accessible through the financial service organization system. An advantage to a non-client based application may be that upgrades may be performed globally on the financial service organization system. Each client or user may not need to individually upgrade an image capturing program located on the user system. The link or icon for the image capturing program may be positioned in a section of the browser associated with the financial service organization system graphical interface, such as a section of the graphical interface that includes a transaction number. An advantage of accessing the image capturing program through a graphical interface of a financial service organization system that is in a web browser may be a user's access may increase. A user may not need to download or install additional software on the user system to operate the image capturing program. By accessing the image capturing program through a web browser linked to a financial service organization system, a user may access the image capturing program from any computer that has access to the Internet. A further advantage may be when images are stored on a database of a financial service organization, the images may be accessible from multiple locations or from any computer connected to the Internet.

User system may link the image to an identifier. Image capturing program may automatically link the image to an identifier. A user system may concurrently link an image with more than one identifier such as a borrower name and a loan number. The image may be linked to an identifier associated with a financial transaction a user is currently accessing. The user may be prompted prior to linking an image with an identifier to confirm appropriate linkage. A user may be prompted to enter one or more identifiers to be associated with the image. In an embodiment, a user system may transmit an image with an identifier including a user system number. A financial service organization system may use a user system number to link an image with one or more other identifiers such as a loan name and/or number. When a server of a financial service organization system stores an image, the image may be linked to identifiers generated by the server and not the identifiers transmitted by the user system.

In certain embodiments, an image or image may be automatically linked with one or more identifiers. An image capturing program may automatically link the captured image to one or more identifiers and/or automatically transmit the image to a financial service organization system for store in a memory of the financial service organization. If a user ran an image capture program located on the user system, the user would have to manually enter a file name and a storage location. For example, a user may access financial transaction through a web browser on the user system. In an embodiment, a user may only be able to access one financial transaction at a time. A user may access the Internet through the web browser. A link on web browser may direct a viewable window in a browser to a web address or a user may enter a web address to view. In one embodiment, a user may not enter the web address the user seeks to access in the toolbar of the web browser, but rather in a field associated with a graphical interface the financial service organization system. When a user accesses a website, the user may capture an image or image of the website using an image capturing program at least partially running on the user system. The image capturing program may automatically link the captured image to one or more identifiers associated with the financial transaction the user is currently accessing. In one embodiment, the image capturing program may automatically link the image of the website to the loan number, borrower number, and/or lender name of the loan the user is concurrently accessing. When an image is linked to more than one identifier, it may facilitate location of relevant documents. For example, if an image is only stored under a file name it may only be recalled by the file name. When an image is linked to multiple identifiers, a single image may be recalled by accessing any of a plurality of documents or by querying any of several identifiers. This may be advantageous to auditors or other users seeking complete information about a policy or policyholder.

A user may save an image on the user system. A user may email or transmit the image to another user and/or a financial service organization system. A user may delete an image from the user system the financial service organization system. A user may print an image. A user may print an image with one or more associated or linked identifiers.

In some embodiments, a user system may transmit an image to financial services organization. An identifier associated with an image may be transmitted to a financial service organization system. A user system may transmit an image via the Internet, a WAN, or a LAN. In certain embodiments, a user system may be directly coupled to a financial service organization system.

A financial service organization system may include a database or repository. Images transmitted to a financial service organization system may be stored on a database. Data including images in a database may be categorized. Data may be categorized according to identifiers and/or user entered parameters. In some embodiments, a financial service organization system includes a database with documents associated with one or more identifiers. Each document may be recalled or access by one or more of the identifiers. Data in the database may be categorized by the identifiers. As new documents are added to the database, they may be associated with the existing identifiers that are the same or similar to identifiers transmitted with the new document. A financial service organization system may categorize a transmitted image with an existing entry or a new entry in a database. For example, a database of a financial service organization system may include credit card transactions. Data in the database may include credit card numbers, transaction amounts, and/credit card issuers. As new credit card transactions are entered into a database, they may be associated with the credit card issuer identifier that already exists in a database. In one embodiment, an image of a credit history linked to a credit card holder name may be transmitted to a financial service organization system. The financial service organization system may store and associate the image of the credit history with previously existing entries associated with the credit card holder name. Unlike with print screen functions, the financial service organization system may automatically store and associate images or images with previously existing data in a database.

An image and an identifier associated with the image may be stored in a database. One or more identifiers may be used to recall an image from a database. In certain embodiments, an identifier may be associated with more than one image. The identifier may be used to recall all images associated with the identifier. In an embodiment, more than one identifier may be associated with an image. The image may be recalled using a single identifier or any combination of the identifiers associated with the image. An image may be recalled when data also associated with a same identifier as the image is accessed (e.g., when a loan document is accessed all images associated with that loan number and/or name may be recalled).

In some embodiments, an identifier may be a date. A user may recall all images in a date range using the identifier in a query of a database where the images are stored. By recalling all images in a date range, a user may be able to market interest rates, and/or federal interest rates in a given time period. Since a user may recall images in a date range, if a financial transaction is missing an image of interest rates an image corresponding to a similar date period may be recalled to obtain the needed or missing information.

An image capturing program on the user system may transmit an image to a financial service organization system. A user may be required to prompt transmission of an image to a financial service organization system. An image capturing program may automatically transmit an image to a financial service organization.

User system may be configured to transmit an image to financial service organization system. Image capturing program at least partially running on user system may be configured to automatically transmit a copy of the image or the image to a financial service organization system. Image capturing program may create a prompt displayed on the user system. The prompt may inquire whether the user would like to send an image to a financial service organization system. In an embodiment, a user may manually click a button on the web browser or select a command for the image to be transferred to financial service organization system. In one embodiment, an image may be automatically transferred to financial service organization system.

A financial service organization system may be configured to receive images transmitted by a user system. A financial service organization system may include an image storage program. An image storage program may be a short application program or subroutine configured to receive and store images. An image storage program may be written in any programming language including JAVA or C++. An image storage program may be designed to receive transmitted images and/or identifiers. An image storage program may transmit a message to a user system to confirm receipt and/or storage of an image. The image storage program may automatically transmit one or more messages to a user system when the user system transmits an image to the financial service organization system. A message sent to user system may include a location of an image in a database. The image storage program may store transmitted images in a memory, database, or repository. In an embodiment, image storage program receives images transmitted from a user system and stores them in a database such that the image may be retrieved from a database using one or more of the identifiers associated with the image. The image storage program may transmit images into a database such as a document manager. A document manager may integrate with various software systems; provide instant access to files; consolidate documents from multiple sources into a single view; substantially reduce printing, assembling and mailing costs associated with documents; and improve efficiency of network and computing resources. Incorporating images into a document manager may allow a user to view a variety of documents including one or more images in a single view.

An image may be transmitted with one or more identifiers. In an embodiment, a financial service organization system may automatically link an image to an identifier. Automatically linking a snapshot with an identifier may reduce the likelihood that a snapshot is incorrectly associated with an identifier (e.g., when a user must enter a file name or number, the user may enter the wrong name or number and cause the image to be lost or become incorrectly linked to a different financial transaction). An image may be transmitted with an identifier including, but not limited to, user name and/or number, user system name and/or number, and node number. A financial service organization system may use the identifier number associated with the user or user system to automatically generate one or more additional identifiers such as financial transaction name or number, borrower name, and/or borrower number. A financial service organization system may automatically generate identifiers based on loans or loan applications accessed by a user (e.g., last loan application generated by the financial service organization system for the user system).

A financial service organization system may store images on a memory. A memory may include an installation medium (e.g., a CD-ROM or floppy disks, a computer system memory such as DRAM, SRAM, EDO RAM, Rambus RAM, etc.) or a non-volatile memory such as a magnetic media (e.g., a hard drive or optical storage). Memory may also include other types of memory or combinations thereof A financial service organization system may store images in a database of a financial service organization system.

A financial service organization system may include a dynamic database packageset switching system configured to allow user systems to access a database through different software applications as described by U.S. patent application Ser. No. 09/699,021 to Bobbitt et al., entitled “CONFIGURING DYNAMIC DATABASE PACKAGESET SWITCHING FOR USE IN PROCESSING BUSINESS TRANSACTIONS”, filed Oct. 27, 2000; U.S. patent application Ser. No. 09/699,058 to Doughty et al., entitled “PROCESSING BUSINESS TRANSACTIONS USING DYNAMIC DATABASE PACKAGESET SWITCHING”, filed Oct. 27, 2000; U.S. application Ser. No. 09/699,056 to Doughty, entitled “PROCESSING BUSINESS DATA USING USER-CONFIGURED KEYS”, filed Oct. 27, 2000; and U.S. patent application Ser. No. 09/699,037 to Doughty, entitled “CONFIGURING KEYS FOR USE IN PROCESSING BUSINESS DATA”, filed Oct. 27, 2000. Using a dynamic database packageset switching system may allow a user on user system to access images when parameters (e.g., credit card issuer, interest rate, etc.) are associated with a different identifier than the identifier used for the same parameter in the software application that originally transmitted the image to the database.

In an embodiment, a user may capture images of a CPI. When accessing a financial transaction, a first user may view documents or links to documents such as images of CPI, loan terms, and/or payments by borrower entered by second user on a different software application than first user. In another embodiment, a user may capture images of federal interest rates. When accessing a financial transaction such as a loan, a first user may view documents or links to documents, through a first software application, such as: images of federal interest rates; images of collateral information; electronically scanned images of deeds, titles, and/or checks; a loan application created by a second software application that is different from the first software; and/or a copy of a transfer of money from the loan to a bank account performed by a third software application which is different from the first software application. By storing captured images in a document manager, a user accessing information on a financial service organization may have access to numerous documents.

Security software and restrictions may restrict a user's ability to copy images on a website. Images and/or text on a web page may be encrypted to restrict image copying. In some embodiments, a user may desire to capture an image of a website with security software/restrictions and/or encryption. Image capturing program may be configured to allow copying of such websites. Image capturing program may prompt a user to certify that the user is attempting to copy a website not owned by the user and that the copying is not harmful and/or not illegal. For example, when a user clicks the “Capture Image” button on user's browser, a pop-up box may require a user to “Agree” or “Disagree” that user is attempting to copy a website the user does not own but that such copying is not harmful. A prompt to certify not harmful and/or not illegal copying may be transmitted to a user's web browser so that the web browser allows an image of the website to be captured.

In some embodiments, a financial service organization may recall one or more images. A financial service organization system may recall one or more images associated with one or more identifiers when a user system prompts a financial service organization system to recall a financial transaction. A user system may recall an image using one or more identifiers. A user system may transmit identifiers to a financial service organization system. A financial service organization system may recall all images associated or linked with the transmitted identifiers and transmit all or at least a portion of the images to the user system.

In certain embodiment, a financial service organization system may automatically recall all or at least one image linked to one or more identifiers associated with a financial service organization when a user system accesses the financial transaction. A financial service organization system may automatically recall all or at least one image associated with financial transaction associated with an entity when a user system accesses the entity's records.

In an embodiment, a user may access a financial transaction stored on a financial service organization system through the Internet. Internet web browsers may include, but are not limited to, Internet Explorer or Netscape. A financial service organization system may recall a stored transaction, loan or loan application; transmit the requested transaction, loan, or loan application; and transmit at least some information about images associated with the requested transaction, loan, or loan application (e.g., names of images associated with a financial transaction, creation dates of images, and/or links configured to recall images). When a financial transaction, loan, or loan application is displayed in a window of a web browser, hyperlinked text and/or toolbars may be available. Images associated with a financial transaction, loan, or loan application may be displayed on the web browser as hyperlinked text. When a user clicks on hyperlinked text, an image associated with the hyperlinked text may be recalled from a financial service organization system, transmitted to the user system, and displayed on the user system. A user may print or save a copy of the image on the user system.

In some embodiments, a financial service organization system may be configured to receive one or more transmitted images from one or more user systems. An identifier may be transmitted with the image. In an embodiment, a financial service organization system automatically associates an image with at least one identifier. For example, a financial service organization system may automatically associate an image with a financial transaction (e.g., a loan, a credit card transaction, and/or bank transaction) a user system is currently accessing or the financial transaction a user system accessed. A user system may transmit an image and one or more identifiers, such as transaction name and/or number, borrower name and/or number, lender name and/or number, and/or user name and/or number to a financial service organization system. A financial service organization system may store an image and one or more identifiers in a memory or database. When a user system requests a financial transaction, such as, for example, a loan, at a later date, a financial service organization system may recall images associated with the financial transaction using the identifiers stored in the database or a memory. A user system may be able to recall all images associated with a borrower name and/or number, lender name and/or number, and/or entity name and/or number through the financial service organization system. A financial service organization system may automatically recall and transmit to a user system at least some of the images associated with an identifier when a user system recalls an loan application, a loan, a credit card transaction, extends a loan, etc. For example, a financial service organization system may automatically recall and transmit to a user system all the images (e.g., interest rates, etc.) associated with a financial transaction accessed by the user system.

In some embodiments, a user system may be used to process a financial transaction such as a loan application. A user system may access a loan application template through the Internet. Loan application template may be stored in a memory of a financial service organization system. A user may search the Internet to identify federal interest rates, common loan interest rates available on the web, CPI and/or other indices, and/or federal regulations governing loan interest rates. Often as interest rates changes, websites listing interest rates may change to include more recent interest rates and data concerning past interest rates may be unavailable. By capturing an image of a website, a record may be kept of factors used to determine an interest rate for a loan, federal interest rates, and/or CPI for a given time. A user may also use the Internet to obtain a credit history, credit report, or credit score of a borrower. Credit history and credit scores may be available from various websites. A user may capture an image of a credit history, report, and/or score. By associating a loan application with the image of interest rates and/or credit information, a second user may be able to determine the factors that affected a loan application and/or an auditor may have a complete record of factors used in determining terms of a loan.

An image may be linked to an identifier such as a loan number, borrower name, creditor name, etc. An image captured by a user system may be transmitted to a financial service organization system. An identifier may be transmitted with an image to a financial service organization system. A financial service organization system may be configured to automatically associate an image with an identifier. For example, a financial service organization system may automatically associate a transmitted image with the user or user system transmitting the image, a loan number previously accessed by the user system transmitting the image, a borrower name, and/or a user input identifier. Financial service organization system may save an image and identifier in a memory or database. A user may recall the image using one or more of identifiers associated with the image. A financial service organization system may automatically recall and transmit to a user system all the images (i.e., interest rates, credit information, etc.) associated with a particular loan accessed by a user system.

A user may capture an image of a web page as proof of collateral for a loan. A user may access a loan or loan application using a user system. A loan or loan application may be stored on a financial service organization system. A user may use the Internet to access information on collateral used in a loan, such as bank statements, images of processed checks obtained from a bank website, and/or recorded deeds. A user may capture an image of the website containing information on collateral and link the image with one or more identifiers, such as collateral identity, loan or loan application number, and/or borrower name. User system may transmit an image and one or more identifiers to a financial service organization system. Financial service organization system may store images and/or identifiers in a memory or database. A user may recall images associated with an identifier using the financial services organization system. Financial service organization system may automatically recall and transmit to a user system at least some of the images associated with an identifier when a user system recalls a financial transaction. For example, a financial service organization system may automatically recall and transmit to a user system all the images, such as deeds, or bank statements, associated with a particular loan accessed by the user system.

In certain embodiments, a user may access a transaction template on a financial service organization system through the Internet. Transaction template may be viewable on a web page. Transaction template may calculate loan rates, transmit credit card debits and/or credits, and/or manage financial transactions. A user may enter parameters (e.g., borrower name, loan amount, credit card issuer, transaction amount, dates, etc.) in transaction template. Transaction template may be configured to calculate and/or transmit parameters and produce an output such as a number, report, or signal that the information was transmitted correctly. A user may desire to retain a copy of parameters used. A user may capture an image of the parameters entered into a transaction template. Unlike a “Save As” feature on many web browsers, capturing an image of the transaction template on a web page may include parameters entered in the fields of a transaction template. Images captured and identifiers linked to the images may be transmitted to a financial service organization system. In some embodiments, a financial service organization system automatically links transmitted images with one or more identifiers. Financial service organization system may store images and linked identifiers in a memory or database. A financial service organization system may recall images by one or more of the associated identifiers. A user system directly coupled or coupled via a network may recall images from a financial service organization system. Financial service organization system may automatically recall and transmit to a user system at least some of the images associated with an identifier when a user system recalls a financial transaction. For example, a financial service organization system may automatically recall and transmit to a user system all the images associated with a particular loan accessed by a user system.

Images may be used in conjunction with handwriting pattern recognition (e.g., signature recognition). A user may use capture an image of a document with a signature on it on a website, such as a bank website or a website with recorded deeds or titles. An image with the signature may be transferred to a financial service organization system with one or more identifiers. A software application at least partially running on the user system or a financial service organization system may compare a signature on the captured image with a second signature. A second signature may be obtained from an electronic copy of a check; an electronic signature from a touch pad, such as those available from NCI, Topaz Systems, Inc, Symbol Technologies, and/or VeriFone, Inc; and/or an image of a website with a signature, such as an electronic image of a check on a bank website. Financial service organization system may include an image storage program to compare and/or verify a signature in a captured image prior to or after storing the image in a memory or database. Financial service organization system may transmit a message to a user when signatures are similar or dissimilar.

In certain embodiments, the user system may be coupled to a financial service organization system through a network (e.g., direct couple to other computers, WAN, LAN, the Internet, and/or combinations thereof). A user system may include a CPU and/or a memory. A memory may be coupled to the CPU. The user system memory may store program instructions. In an embodiment, program instructions may be at least partially executed by the CPU of the user system. The program instructions may include requesting a financial transaction through a web browser. The financial transaction may be stored on a memory of the financial service organization system. The web browser may provide access to a financial transaction stored in a memory or a database of a financial service organization system. The user system may then access a website through the web browser. A user may type a web address in a field of a section of the web browser generated by the financial service organization system. A user may select a link to a web address in a field of a section of the web browser generated by the financial service organization system. In some embodiments, a web browser may be configured such that in a viewable window a user may access the Internet while viewing links to documents associated with a policy in another section of the browser.

A user may desire to capture an image of the website. In an embodiment, program instructions may include capturing the image of the website through the web browser. In an embodiment, an icon or command associated with an image capturing program on the financial service organization system may be positioned in a section of the web browser generated by the financial service organization system. When a user selects the icon or the command, the image capturing program may at least partially run on the user system. The program instructions may include automatically linking the image to one or more identifiers. The program instructions may include transmitting an image and/or one or more identifiers to a financial service organization system.

In one embodiment, a financial service organization system may include a CPU and a memory coupled to the CPU. The financial service organization system memory may store programs that may be at least partially executed by the CPU of the financial service organization system. The program instructions may include receiving the image from the user system. The program instructions may include storing the image and one or more identifiers in a memory of the financial service organization system. The program instructions may include transmitting or sending a message to the user after receiving the image and/or identifiers. The message may confirm receipt of the image and/or transmit a location of the image on the financial service organization system.

In some embodiments, managing financial transactions may include accessing a financial transaction through a user system across a network via one or more Internet protocols (e.g., TCP/IP, HTTP). A user may access a financial transaction through a web browser. The financial transaction may be stored on a financial service organization system. A user may access financial transactions stored on the financial service organization system via the web browser. A user may access a website across the network via one or more Internet protocols. A user may access a website through the same web browser the user accessed the financial transaction. In an embodiment, a user system may only access one financial transaction at a time. A user system may capture an image of the website and link the image to one or more identifiers. A user system may link the captured image with an identifier associated with the accessed financial transaction. A user system may transmit the image to the financial service organization system across a network via one or more Internet protocols. A financial service organization system may receive the image and store the image and one or more identifiers in a memory of the financial service organization system.

In certain embodiments, a system for managing financial transactions may include a carrier medium with program instructions. The program instructions may include transmitting a financial transaction to a user system across a network via one or more Internet protocols when a user requests the financial transaction. A user may also access a website across a network via one or more Internet protocols. A user may first access a financial transaction and then search websites. A user may desired to save an image of a website used, for example, to create a policy and/or determine a premium. Program instructions may include capturing an image of the accessed website. The program instructions may include automatically linking the image to one or more identifiers. In one embodiment, the image may be linked to the credit card account number of the financial transaction the user last viewed. In an embodiment, the program instructions may include transmitting the image across a network via one or more Internet protocols to the financial service organization system from the user system. The program instructions may include storing the image and one or more identifiers in a memory of the financial service organization system. In one embodiment, program instructions may include sending a message to a user system after receiving the image. The message may indicate that the image was successfully sent and/or received. The message may indicate the different identifiers to which the image is linked.

In certain embodiments, capturing an image of an error message may aid a user in obtaining technical support. A user may access a financial transaction through a web based interface. The web based interface may allow a financial service organization system to transmit information, files, or other data to a user system and/or run programs on a user system. Sometimes a user may encounter an error when accessing financial transaction or running a program from the financial service organization system. A user may capture an image of the error message. A user may send an image to technical support via the Internet or email. An image of the error message may be linked to an identifier and transmitted to a financial service organization system. An image of the error message may be linked to an identifier and transmitted to a financial service organization system. In an embodiment, an image of an error message may be linked with an identifier including a user name and transmitted to a financial service organization system. A financial service organization system may store the image linked to a user name in a database. Technical support agents may recall an image of an error message using a user name.

Technical support agents of a financial service organization system may be able to access the financial transaction and view the image error message. For example, a user may contact technical support and identify the transaction number of the financial transaction user was working on when an error occurred. Technical support can recall the financial transaction using the transaction number. Financial service organization system may recall all images associated with the financial transaction number and technical support may view an image of the error message. In an embodiment, a user emails image to technical support. By capturing a substantially similar representation of the error message received by a user, technical support may be facilitated. A user may also send an image of error message to other users to obtain advice regarding the error.

Various embodiments may also include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, may be conveyed via a communication medium such as a network and/or a wireless link.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method for managing insurance policies between a user system and an insurance claim processing system comprising:
accessing an insurance policy through a user system, wherein the insurance policy comprises one or more identifiers;
accessing a website;
capturing an image of the website;
linking the image to one or more identifiers;
transmitting the image to the insurance claim processing system; and
storing the image and one or more identifiers in a memory of the insurance claim processing system.

2-4. (canceled)

5. The method of claim 1, wherein the image comprises a substantially similar representation of a website.

6-13. (canceled)

14. The method of claim 1, wherein capturing an image comprises reproducing similar representations of pixels of a website in an image file.

15. (canceled)

16. The method of claim 1, wherein linking the image with one or more identifiers comprises automatically coupling the image with the one or more identifiers such that when the image is transmitted the one or more identifiers are transmitted.

17. (canceled)

18. The method of claim 1, wherein transmitting the image comprises transmitting the image via the Internet.

19-21. (canceled)

22. The method of claim 1, wherein the insurance claim processing system is configured to recall the image from the memory when an identifier associated with an insurance policy requested by a user system and the identifier linked to the image are the same.

23. The method of claim 1, wherein storing the image and one or more identifiers in a memory comprises storing the image in a database of the insurance claim processing system.

24. The method of claim 23, further comprising categorizing the images in a database.

25. The method of claim 1, further comprising:
requesting an insurance policy from the insurance claim processing system, wherein the requested insurance policy comprises one or more associated identifiers;
comparing one or more associated identifiers with identifiers linked to images in a database;
recalling images with one or more identifiers that are the same as one or more of the associated identifiers; and
transmitting the recalled images to a user system.

26-27. (canceled)

28. The method of claim 1, further comprising:
automatically verifying, to a user's web browser, that capturing an image of a website does not harm the website, prior to capturing an image of a website.

29-56. (canceled)

57. A carrier medium comprising program instructions, wherein the program instructions are executable to implement:
accessing an insurance policy through a user system, wherein the insurance policy comprises one or more identifiers;
accessing a website;
capturing an image of the website;
linking the image to one or more identifiers;
transmitting the image to the insurance claim processing system; and
storing the image and one or more identifiers in a memory of the insurance claim processing system.

58-90. (canceled)

91. A method for managing financial transactions between a user system and financial service organization system comprising:
accessing a financial transaction through a user system, wherein the financial transaction
comprises one or more identifiers;
accessing a website;
capturing an image of the website;
linking the image to one or more identifiers;
transmitting the image to the financial service organization system; and
storing the image and one or more identifiers in a memory of the financial service organization system.

92-94. (canceled)

95. The method of claim 91, wherein the image comprises a substantially similar representation of a website.

96-108. (canceled)

109. The method of claim 91, wherein linking the image with one or more identifiers comprises automatically coupling the image with the one or more identifiers such that when the image is transmitted the one or more identifiers are transmitted.

110. (canceled)

111. The method of claim 91, wherein transmitting the image comprises transmitting the image via the Internet.

112-114. (canceled)

115. The method of claim 91, wherein the financial service organization system is configured to recall the image from the memory when an identifier associated with a financial transaction requested by a user system and the identifier linked to the image are the same.

116. The method of claim 91, wherein storing the image and one or more identifiers in a memory comprises storing the image in a database of the financial service organization system.

117. (canceled)

118. The method of claim 91, further comprising:
requesting a financial transaction from the financial service organization system, wherein the requested financial transaction comprises one or more associated identifiers;
comparing one or more associated identifiers with identifiers linked to images in a database;
recalling images with one or more identifiers that are the same as one or more of the associated identifiers; and
transmitting the recalled images to a user system.

119. The method of claim 118, wherein transmitting recalled images comprises transmitting a link to the recalled images, and wherein the link to the recalled images is configured to recall an image of the recalled images.

120. The method of claim 91, further comprising:
prompting a user on a user system to verify that capturing an image of a website does not harm the website, prior to capturing an image of a website.

121-185. (canceled)
